(19) United States
(12) Patent Application Publication
(10) Pub. No.: US 2020/0029601 A1
(43) Pub. Date: Jan. 30, 2020

(54) PHENYLACRYLIC ACID SOLUTION FOR BROAD SPECTRUM ANTIMICROBIAL APPLICATIONS FOR FOODSTUFFS

(71) Applicant: KLF LABS LLC, Bradenton, FL (US)

(72) Inventor: Kyle Ferguson, Bradenton, FL (US)

(21) Appl. No.: 16/402,868

(22) Filed: May 3, 2019

Related U.S. Application Data
(60) Provisional application No. 62/703,086, filed on Jul. 25, 2018.
(60) Provisional application No. 62/781,715, filed on Dec. 19, 2018.

(51) Int. Cl. A23L 3/3508; A01N 37/10; A01N 37/06; A01N 37/40; A01N 37/36; A23L 3/3526

(52) U.S. Cl. CPC A23L 3/3508; A01N 37/10; A01N 37/06; A23V 2002/00; A01N 37/36; A23L 3/3526; A01N 37/40

(57) ABSTRACT

The present compounds and methods relate to formulations of a food preservative solution that includes a preservative agent, a stabilizing agent and a potentiating agent, wherein the potentiating agent amplifies activity of the preservative agent. Embodiments of the food preservative solution may utilize a compound including a preservative agent, a stabilizing agent and a potentiating agent to prevent food spoilage by presenting antimicrobial and antifungal properties.

### CROSS REFERENCE TO RELATED APPLICATIONS

This application claims the benefit of and priority under 35 U.S.C. §§ 119, 120 to:

U.S. Provisional Patent Application No. 62/703,086, filed Jul. 25, 2018, entitled, “PHENYLACRYLIC ACID SOLUTION FOR BROAD SPECTRUM ANTIMICROBIAL APPLICATIONS FOR FOODSTUFFS”; and
U.S. Provisional Patent Application No. 62/781,715, filed Dec. 19, 2018, entitled, “PHENYLACRYLIC ACID SOLUTION FOR BROAD SPECTRUM ANTIMICROBIAL APPLICATIONS FOR FOODSTUFFS,” each of which is incorporated herein by reference in its entirety.

### TECHNICAL FIELD

The present disclosure generally relates to formulations of a food preservative solution with a broad spectrum of applications and, wherein, embodiments of the food preservative solution includes a preservative agent, a stabilizing agent and a potentiating agent. The present disclosure provides formulations of a food preservative solution capable of protecting against spoilage by bacteria and fungi for a large variety of food groups. The present disclosure further provides the use of the preservative solution as it relates to alimentary products containing the preservative system.

### BACKGROUND

Currently, there is an imbalance between the growing food demand of the world population and the global agricultural output. This is partially due to the rapid emergence of multidrug-resistant pathogenic microbes that poses a considerable threat to food security by way of destroying crops. Plant protection in general and the protection of crops against plant diseases in particular have an obvious role to play in meeting the growing demand for food quality and quantity. Roughly, direct perennial yield crop losses caused by pathogenic microbes account for ˜20% worldwide and 10% loss post-harvest. Present food technologies utilize an array of physical, chemical, and biological processes and agents to preserve food and prevent the transmission of disease via foodstuffs. These agents include antioxidants and compositions which kill or inhibit harmful microbes, thereby preserving food. However, the emergence of multi-drug resistant microbes, as well as the tightening regulatory environment world-wide is requiring the need for new broad-spectrum antimicrobial solutions for food preservation.

Food spoilage usually occurs because of enzymatic, bacterial, or fungal action. Specifically, fungal pathogens from the genera Aspergillus, Alternaria, Fusarium, Penicillium can contaminate foodstuffs with mycotoxins. Mycotoxins produced by these fungi include aflaxtonis fumonisins, fusaric acid, and TA/AAL toxins. These mycotoxins are highly toxic to a variety of species including humans and can be found in commercially prepared foodstuffs and animal feed. Serious health problems, such as mycotoxicosis, arise when foodstuffs are ingested that is contaminated with mycotoxin producing fungi.

Mycotoxins in foods are attributable to the presence of toxic fungi at all points in the food supply chain from seed to table. High levels of mycotoxins have been identified in a wide variety of foodstuffs, including beans, cereals, bread, coconuts, peanuts, sweet potatoes, animal feed, beverages, cheese and dairy products. Mycotoxins are heat stable compounds of relatively low molecular weight. Once present in foodstuffs mycotoxins cannot be removed, resulting in unacceptably high levels of mycotoxin contamination such as the foodstuffs must be discarded. It is imperative that new solutions are developed to prevent contamination of these foodstuffs. This will decrease the adverse health effects associated with exposure to these mycotoxins. It is highly desirable for a food preservative to be applicable to all mold species that produce mycotoxins.

Another type of food borne pathogen that contributes to ruined crops, foodstuff spoilage and food-borne sickness are bacterial pathogens. Gram-positive bacteria such as corynebacterial contaminate the surface of a wide variety of foodstuffs and exhibit tolerance to certain common preservatives such as sulfites. Gram-positive bacteria such as bacteria from the Clostridium genus are highly proteolytic and therefore putrefy food. Gram-positive bacteria such as Deinococcus radiodurans is sufficiently thermoduric to survive common commercial procedures such as pasteurization.

Gram-negative bacteria also present a significant threat to food security. Enterobacteriaceae commonly contaminates and proliferates on many raw proteinaceous foods (e.g., steak, chicken, fish, etc.), thereby causing a wide variety of food borne illnesses. Additionally, many Erwinia species cause a wide variety of plant diseases including; soft rots, wilts, and necrosis which kill off many crops. Gram-negative bacteria primarily threaten the security of fresh foodstuffs. Many gram-negative bacteria are becoming increasingly resistant to traditional physio treatments such as cold storage and pasteurization.

Previous methods of treating foodstuffs for bacteria include traditional physio treatment methods, such as pasteurization, and chemo preservative methods, such as the application of antibiotics. However, some bacteria are durable enough to resist common physio treatments. Thus, there is a growing concern that the liberal use of antibiotics will create the emergence of antibiotic-resistant bacteria. This concern supports the immediate development of new antimicrobial solutions for food preservation.

Food preservation by inhibiting the growth of yeasts, molds, lactobacilli, and other spoilage bacteria is difficult for foodstuff that are not subject to the thermal processing (e.g. pasteurization) that kills spoilage in dairy-like products. Fresh fruits and vegetables rapidly deteriorate when exposed to environmental factors that introduce microorganisms which in turn results in food spoilage. Thermally processed foods still encounter spoilage pathogens during storage and transport.

Thus, there is an unmet need for new natural (organic) food preservative solutions that ensure the safety of foodstuffs for consumption without sacrificing the taste, crispness, consumer preferences, or other desired traits of all fresh and processed foods.

### BRIEF SUMMARY OF THE DISCLOSURE

This disclosure combines traditional natural non-toxic preservative agents such as, sorbic acid, phenylacrylic acid, ferulic acid, or associated derivatives, with a potentiating agent with no adverse effect on taste, while extending the time for which these preserving agents exhibit broad antimicrobial activity. This disclosure solves the challenges associated with the most prevalent food preservation solutions available on the market today. By combining a common antimicrobial agent with potentiating agent(s) to increase the antimicrobial agents' longevity, while lowering the amount of acidulate necessary in the food preservative solution. This disclosure meets food preservative needs of the growing global population.

Briefly described, and according to one embodiment, aspects of the present disclosure generally relate to a food preservative solution and methods of developing thereof that include a combination of a phenylacrylic acid or sorbic acid, or derivatives of each thereof, with a potentiating agent such as (Z)-(2-fluoro-2-nitrovinyl)benzene, mandelic acid, 2-nitro-1-phenylethan-1-ol, (Z)-β-Nitrostyrene (E)-(2-nitrovinyl)benzene or associated derivative.

In various embodiments, the present food preservative solution may include antimicrobial agents such as, phenylacrylic acid(s) or sorbic acid combined with potentiating agents such as (Z)-(2-fluoro-2-nitrovinyl)benzene or associated derivative. In various embodiments, the present disclosure relates to a food preservative solution that includes a combination of preservative agents including, but not limited to: 1) phenylacrylic acid; 2) caffeic acid; 3) para-hydroxy phenylacrylic acid; 4) cinnamaldehyde; 5) methyl cinnamate; 6) ethyl cinnamate; 7) sorbic acid; and 8) ferulic acid. In one or more embodiments, the present food preservative solution may include associated antimicrobial agents and edible salts with corresponding potentiating agents including, but not limited to: 1) (Z)-(2-fluoro-2-nitrovinyl)benzene; 2) para-mandelic acid, L-mandelic acid; 3) D-mandelic acid; 4) vanilmandelic acid; 5) para-hydroxymandelic acid; 6) para-methoxymandelic acid; and 7) 1,2 nitro-phenolethanol beta-nitrostyrene. In at least one embodiment, the present food preservative solution may including one or more stabilizing agents including, but not limited to: 1) dextrin (e.g., B-cyclodextrin, etc.); 2) soy protein isolate; 3) whey protein isolate; 4) starch; 5) carrageenan; 6) alginate; 7) carboxymethylcellulose; and 8) chitosan.

In various embodiments, the present food preservative solution may provide desired antimicrobial properties (e.g., such as those unique to phenylacrylic acid), and may extend the efficacy and/or duration of the antimicrobial properties. In one or more embodiments, the present food preservative solution protects foodstuffs against microbial and enzymatic spoilage (e.g., using a combination of one or more potentiating agents and antifungal agents), and preserves taste, appearance and other sensory elements of the foodstuffs.

In various embodiments, the present food preservative solution may include a sufficient amount of an antimicrobial agent such as; phenylacrylic acid, ferulic acids, sorbic acid and coumaric acids. In various embodiments, the present food preservative solution may include a potentiating agent, such as a Ferulic Acid Decarboxylase inhibitor like (Z)-(2-fluoro-2-nitrovinyl) benzene or associated compound. In various embodiments, a stabilizer compound such as, dextrin, chitosan, or an associated food safe stabilizer may also be added to the present food preservative solution. In at least one embodiment the present food preservative solution may be designed to prevent microbiological outgrowth and to kill microbiological species on food, while simultaneously contributing to the pleasant flavor of the food, thus making the food acceptable both organoleptically and microbiologically. In various embodiments, the present food preservative solution may extend the shelf life of foodstuffs, therefore decreasing food spoilage.

According to a first aspect, a compound for preserving foodstuffs including: A) a preservative agent; B) a potentiating agent; and C) a stabilizing agent.

According to a second aspect, the compound of the first aspect or any other aspect, wherein the preservative agent includes up to about 90% by weight of the compound.

According to a third aspect, the compound of the first aspect or any other aspect, wherein the potentiating agent includes up to about 50% by weight of the compound.

According to a fourth aspect, the compound of the first aspect or any other aspect, wherein the stabilizing agent includes up to about 90% by weight of the compound.

According to a fifth aspect, the compound of the first aspect or any other aspect, wherein the preservative agent is selected from the group including: phenylacrylic acid, sorbic acid, ferulic acid, and derivatives of any of the preceding.

According to a sixth aspect, the compound of the first aspect or any other aspect, wherein the potentiating agent is selected from the group including: L-mandelic acid, D-mandelic acid, 1,2 nitroethanol, and 2,2-(Z)-fluoronitrovinylbenzene, and derivatives of any of the preceding.

According to a seventh aspect, the compound of the first aspect or any other aspect, wherein the stabilizing agent is selected from the group including: chitosan, alginate, starch, whey protein isolate, soy protein isolate, and derivatives of any of the preceding.

According to an eighth aspect, the compound of the first aspect or any other aspect, wherein the compound is an aqueous solution.

According to a ninth aspect, a compound for preserving foodstuffs including: A) a preservative agent, wherein the preservative agent is selected from the group including: phenylacrylic acid, sorbic acid, ferulic acid, and derivatives of any of the preceding; B) a potentiating agent, wherein the potentiating agent is selected from the group including: L-mandelic acid, D-mandelic acid, 1,2 nitroethanol, and 2,2-(Z)-fluoronitrovinylbenzene, and derivatives of any of the preceding; and C) a stabilizing agent, wherein the stabilizing agent is selected from the group including: chitosan, alginate, starch, whey protein isolate, soy protein isolate, and derivatives of any of the preceding.

According to a tenth aspect, the compound of the ninth aspect or any other aspect, wherein the preservative agent includes up to about 90% by weight of the compound.

According to an eleventh aspect, the compound of the ninth aspect or any other aspect, wherein the potentiating agent includes up to about 50% by weight of the compound.

According to a twelfth aspect, the compound of the ninth aspect or any other aspect, wherein the stabilizing agent includes up to about 90% by weight of the compound.

According to a thirteenth aspect, the compound of the ninth aspect or any other aspect, wherein the compound is an aqueous solution.

According to a fourteenth aspect, a compound for preserving foodstuffs, including: A) phenylacrylic acid, wherein the phenylacrylic acid includes between about 85%-90% by weight of the compound; B) mandelic acid, wherein the mandelic acid includes between about 5%-10% by weight of the compound; and C) chitosan, wherein the chitosan includes about 5% by weight of the compound.

According to a fifteenth aspect, a method for preserving a foodstuff, wherein the method includes: A) providing in a compound, a potentiating agent, a preservative agent and a stabilizing agent; and B) applying the compound to the foodstuff.

According to a sixteenth aspect, the method of the fifteenth aspect or any other aspect, wherein the potentiating agent is selected from the group including: L-mandelic acid, D-mandelic acid, 1,2 nitroethanol, and 2,2-(Z)-fluoronitrovinylbenzene, and derivatives of any of the preceding.

According to a seventeenth aspect, the method of the fifteenth aspect or any other aspect, wherein the wherein the preservative agent is selected from the group including: phenylacrylic acid, sorbic acid, ferulic acid, and derivatives of any of the preceding.

According to an eighteenth aspect, the method of the fifteenth aspect or any other aspect, wherein the compound is configured to preserve a foodstuff including a pH between about 3-7.5.

According to a nineteenth aspect, the method of the fifteenth aspect or any other aspect wherein providing further includes: A) selecting the potentiating agent, wherein the potentiating agent is selected from the group including: L-mandelic acid, D-mandelic acid, 1,2 nitroethanol, and 2,2-(Z)-fluoronitrovinylbenzene, and derivatives of any of the preceding; B) selecting the preservative agent, wherein the preservative agent is selected from the group including: phenylacrylic acid, sorbic acid, ferulic acid, and derivatives of any of the preceding; and C) selecting the stabilizing agent, wherein the stabilizing agent is selected from the group including: chitosan, alginate, starch, whey protein isolate, soy protein isolate, and derivatives of any of the preceding.

According to a twentieth aspect, the method of the fifteenth aspect or any other aspect, wherein the foodstuff includes a pH between about 3-7.5.

According to a twenty-first aspect, the method of the fifteenth aspect or any other aspect, wherein the compound is an aqueous solution.

### BRIEF DESCRIPTION OF THE DRAWINGS

Aspects of the disclosure and relevant information relating to the disclosure can be found in the attached drawings, which are incorporated herein by reference:

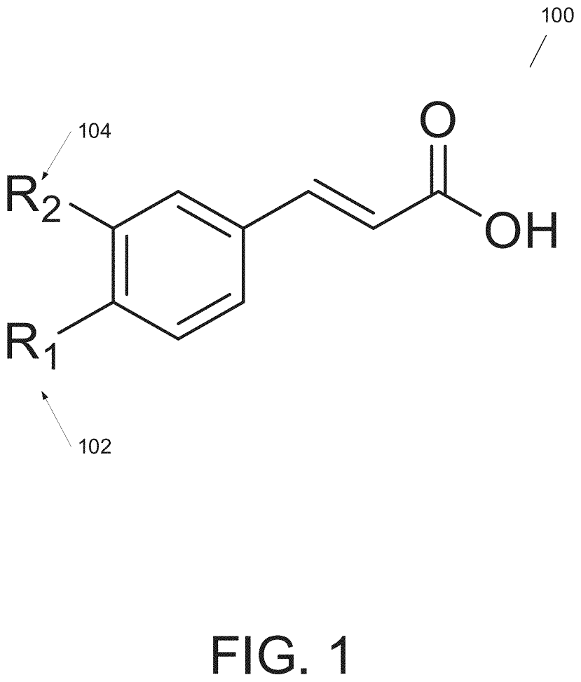

1. FIG. 1 is a drawing of the organic compound phenylacrylic acid or associated derivative.

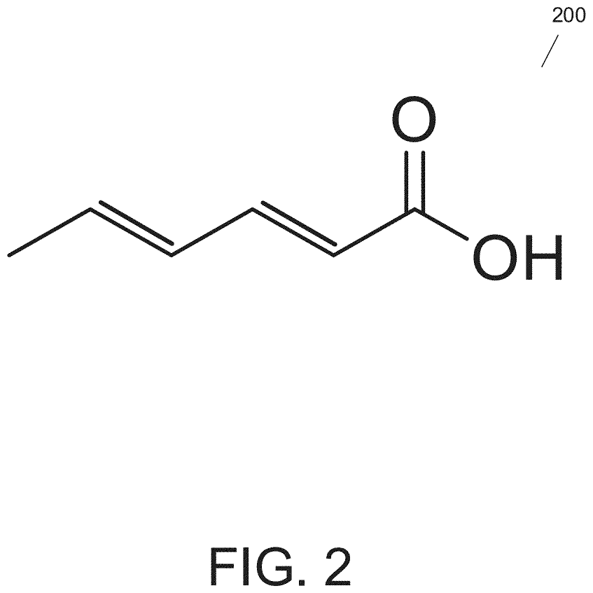

2. FIG. 2 is a drawing of the organic compound 2,4 hexadienoic acid also known as sorbic acid present in at least one embodiment of the present food preservative solution.

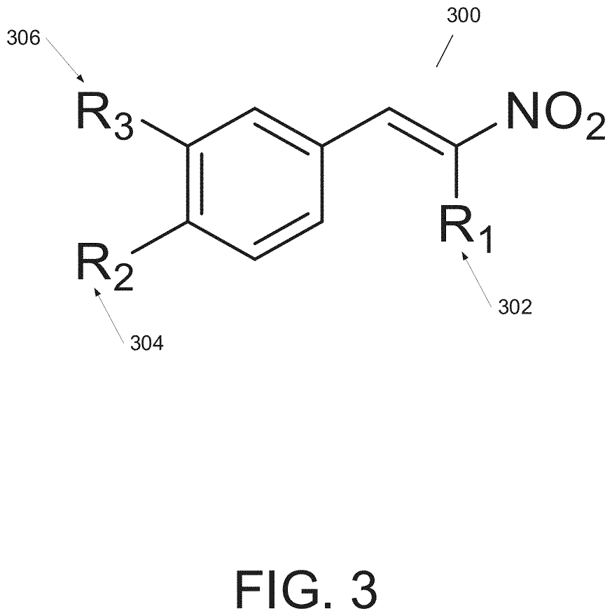

3. FIG. 3 is a drawing of the organic compound beta-Nitrostyrene or associated derivative present in at least one embodiment of the present food preservative solution.

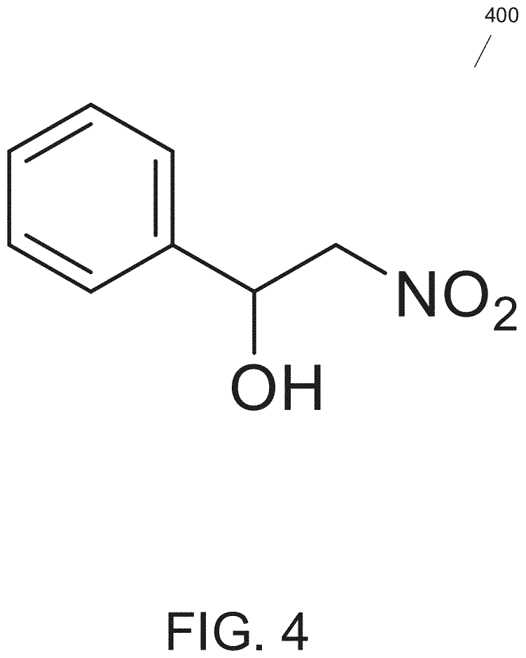

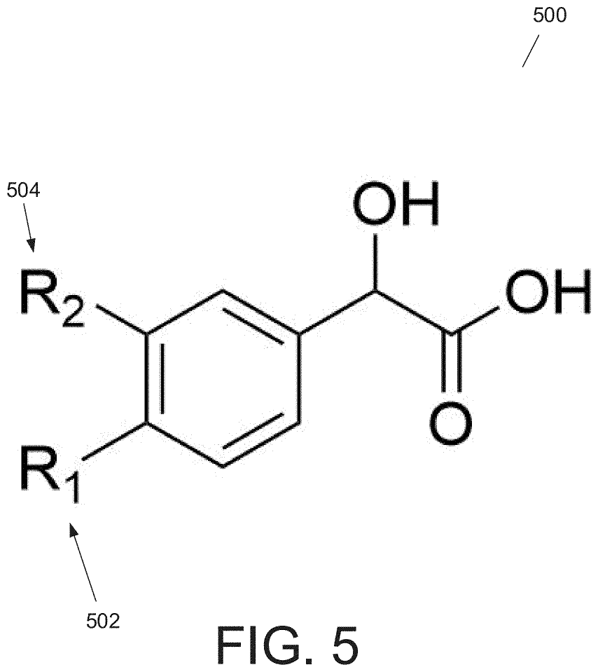

4. FIG. 4 is a drawing of the organic compound 1,2 nitro-phenolethanol or associated derivative present in at least one embodiment of the present food preservative solution.

5. FIG. 5 is a drawing of the compound Mandelic Acid or associated derivative present in at least one embodiment of the present food preservative solution.

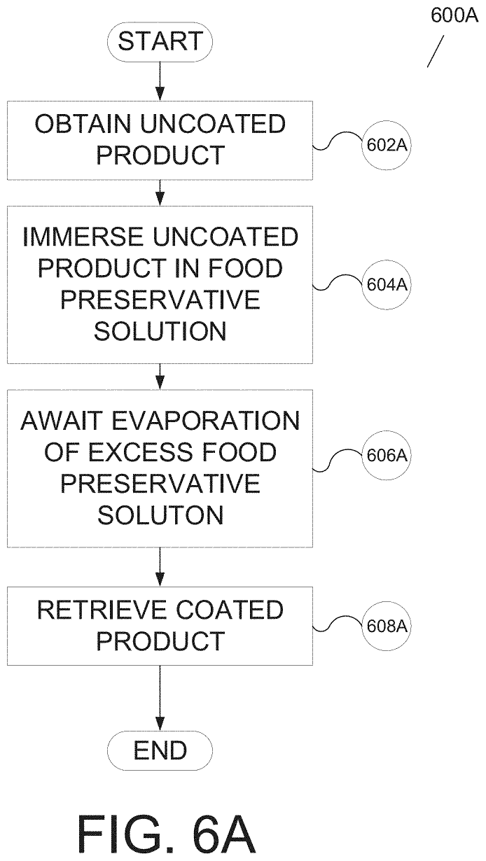

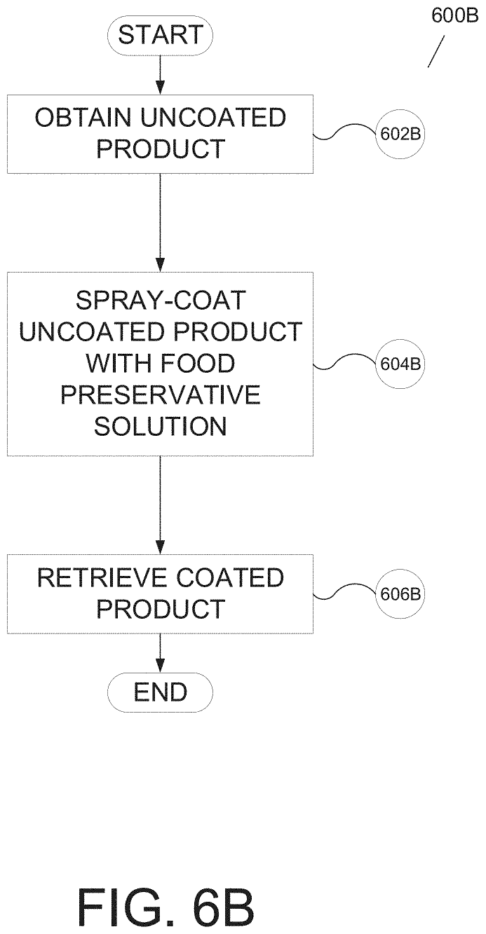

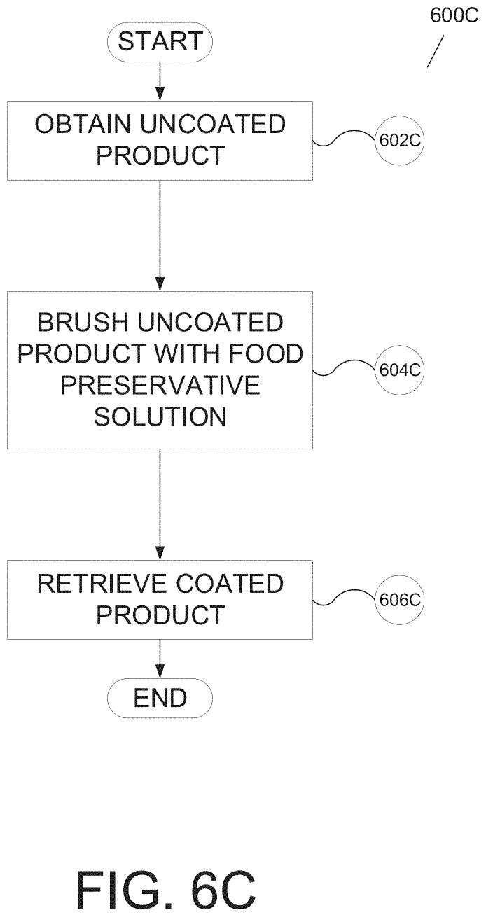

6. FIGS. 6A-C are exemplary flowcharts illustrating techniques for application of a food preservative solution according to a plurality of embodiments.

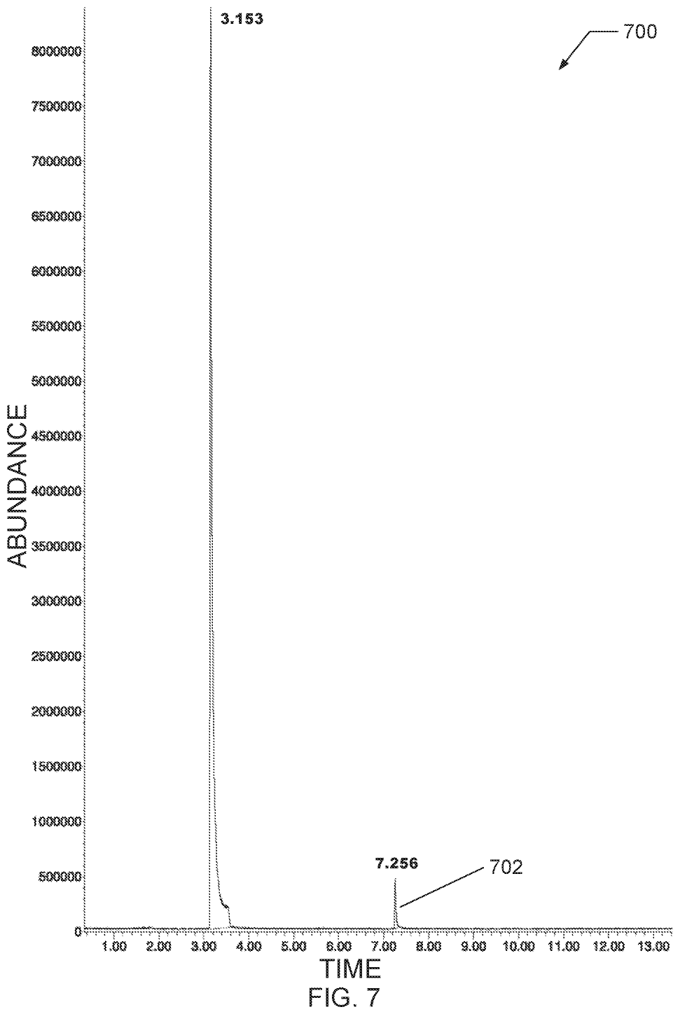

7. FIG. 7 illustrates a mass spectrometry analysis of a standard styrene solution.

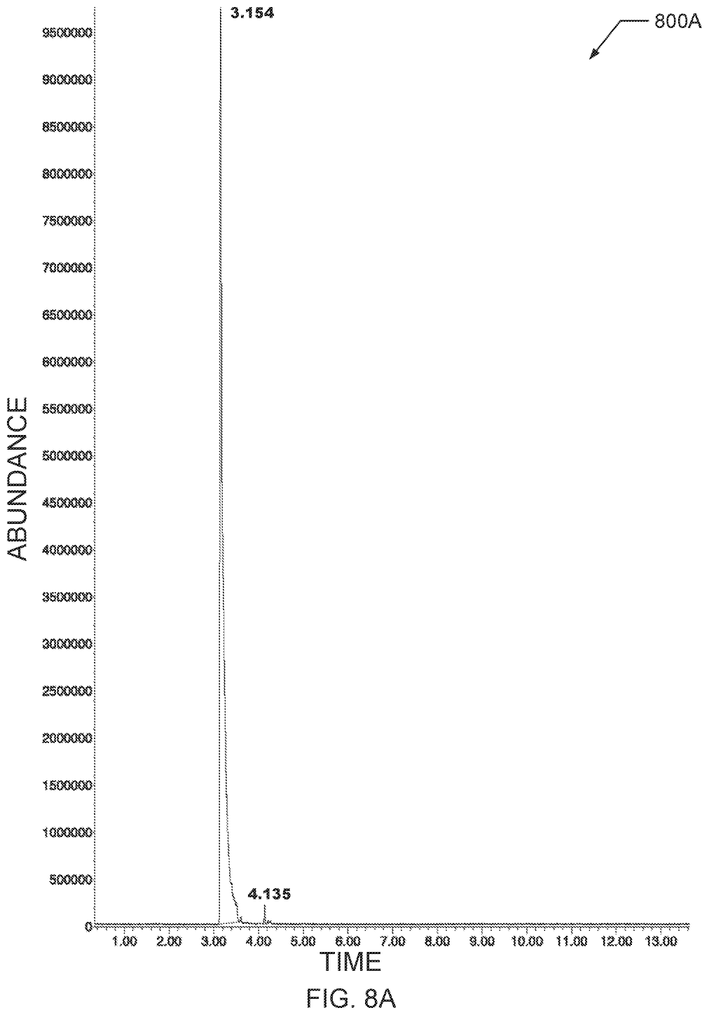

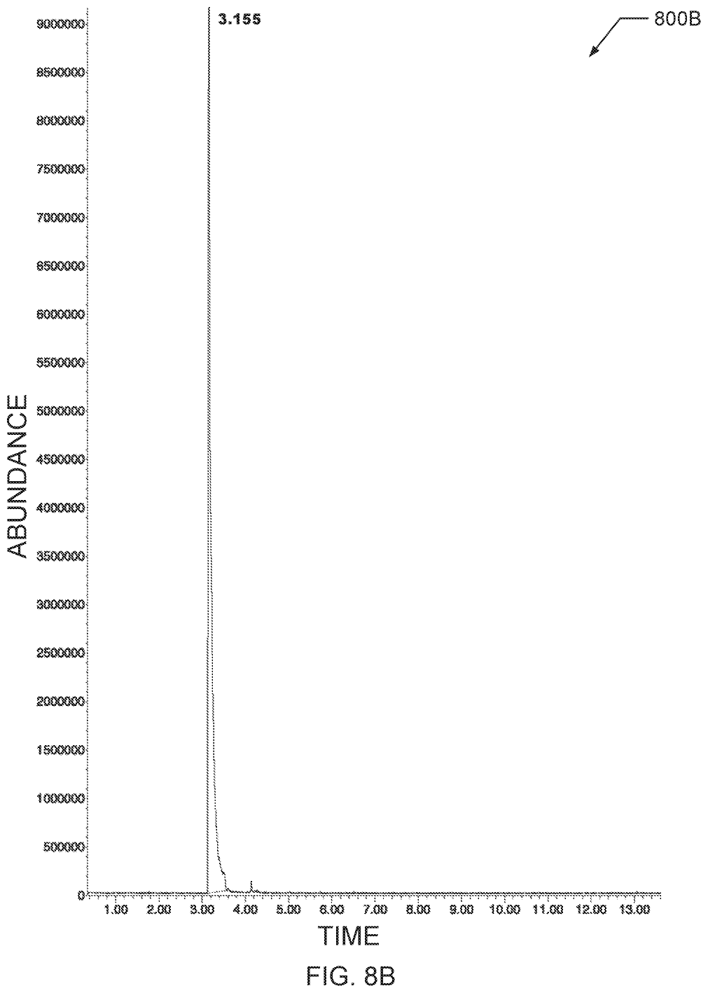

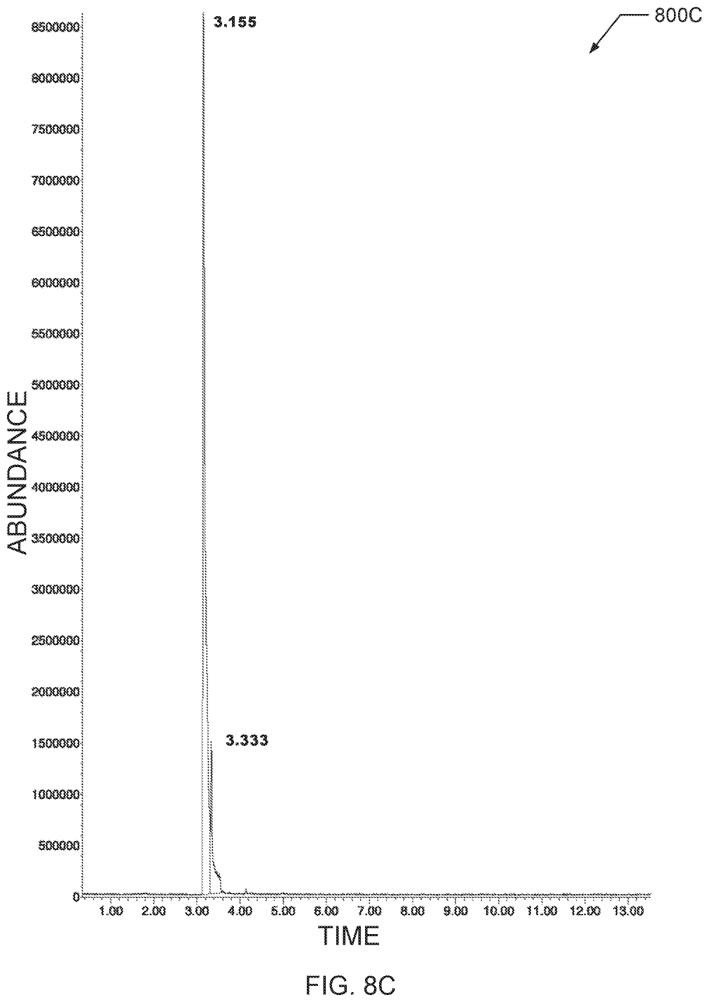

8. FIGS. 8A-C illustrate mass spectrometry analyses of the present food preservative solution according to various embodiments.

### DETAILED DESCRIPTION

This disclosure combines traditional natural non-toxic preservative agents such as, sorbic acid, phenylacrylic acid, ferulic acid, or associated derivatives, with a potentiating agent with no adverse effect on taste, while extending the time for which these preserving agents exhibit broad antimicrobial activity. This disclosure solves the challenges associated with the most prevalent food preservation solutions available on the market today. By combining a common antimicrobial agent with potentiating agent(s) to increase the antimicrobial agents' longevity, while lowering the amount of acidulate necessary in the food preservative solution. This disclosure meets food preservative needs of the growing global population.

For the purpose of promoting an understanding of the principles of the present disclosure, reference will now be made to the embodiments illustrated in the drawings and specific language will be used to describe the same. It will, nevertheless, be understood that no limitation of the scope of the disclosure is thereby intended; any alterations and further modifications of the described or illustrated embodiments, and any further applications of the principles of the disclosure as illustrated therein are contemplated as would typically occur to one of general skill in the art to which the disclosure relates. All limitations of scope should be determined in accordance with and as expressed in the claims.

Whether or not a term is capitalized is not considered definitive or limiting of the meaning of a term. As used in this document, a capitalized term shall have the same meaning as an uncapitalized term, unless the context of the usage specifically indicates that a more restrictive meaning for the capitalized term is intended. However, the capitalization or lack thereof within the remainder of this document is not intended to be necessarily limiting unless the context clearly indicates that such limitation is intended.

### OVERVIEW

Aspects of the present disclosure relate to a food preservative solution including, but not limited to: 1) phenylacrylic acid, ferulic acid, sorbic acid and/or a derivative thereof, wherein the listed acids and/or derivatives thereof may be included independently or in combination; 2) a food safe stabilizer; and 3) a potentiating agent dedicated to the inhibition of both Ferulic Acid Decarboxylase (e.g., or an associated homolog) and an inhibitor such as (Z)-(2-fluoro-2-nitrovinyl) benzene e.g., or an associated analog).

FIG. 1 illustrates an organic compound 100, which is phenylacrylic acid or one or more associated derivatives. In various embodiments, the organic compound 100 may include a first organic constituent 102 and a second organic constituent 104. In one or more embodiments, the first organic constituent 102 may include one or more elements or compounds including, but not limited to: 1) hydrogen; 2) hydroxide (OH); 3) OCH₃; 4) OCH₂CH₃; 5) C1-C10 (e.g., an organic constituent including 1-10 carbon atoms); 6) chlorine (e.g., chloride when bonded); 7) fluorine (e.g., fluoride when bonded); 8) NO₂; 9) CH(CH₃)₂; and 10) C(CH₃)₃. In at least one embodiment, the second organic constituent 104 may include one or more elements or compounds including, but not limited to: 1) hydrogen; 2) hydroxide (OH); 3) OCH₃; 4) OCH₂CH₃; 5) C1-C10 (e.g., an organic constituent including 1-10 carbon atoms); 6) chlorine (e.g., chloride when bonded); 7) fluorine (e.g., fluoride when bonded); 8) NO₂; 9) CH(CH₃)₂; and 10) C(CH₃)₃.

Phenyacrylic acid, also known as cinnamic acid (3-phenyl-2-propenoic acid), is a well-known food ingredient, which obtained generally recognized as safe (GRAS) status in 1965. As will be understood by one of general skill in the art, any soluble cinnamic acid salt may be used in accordance with the present disclosure. Typically, the cinnamate is the water-soluble salt of the phenylacrylic acid. For convenience, the term “cinnamate” may be used herein to refer to any substance containing the phenylacrylic acid anion, in particular, to denote phenylacrylic acid and the salts thereof. Furthermore, a number of phenylacrylic acid derivatives are known and used in the food industry, including p-dimethylaminocinnamate, cinnamaldehyde, cinnamyl acetate, cinnamyl alcohol, cinnamyl benzoate, cinnamyl isovalerate, and cinnamyl phenylacetate, which also may be referred to herein as “cinnamate derivatives.” In accordance with the present disclosure, these derivates are equally suitable for use in the preservative system either alone or in combination with a phenylacrylic acid or other cinnamate salts or derivates. In particular potassium cinnamate or sodium cinnamate is preferred to be used.

Ferulic Acid (3-(4-hydroxy-3-methoxyphenyl)-propenoic acid) is a well-known food ingredient, which obtained FDA approval for food in both the US and EU. As will be understood by one of general skill in the art, any soluble ferulic acid salt may be used in accordance with the present disclosure. Typically, the ferulate is the water-soluble salt of the ferulic acid. For convenience, the term “ferulate” is used herein to refer to any substance containing the ferulic acid anion, to denote ferulic acid and its salts thereof. In particular, potassium or sodium ferulate are preferred to be used.

Phenylacrylic and trans-Ferulic acids are well known acidulants that kill bacteria. These phenylacrylic acids inhibit benzoate 4-hydroxylase a critical enzyme to fungal metabolism. These phenylacrylic acids are known to be metabolized by fungi to form their vinylbenzene derivatives, a volatile organic compound which no longer exhibits any antifungal properties. The mechanism by which these phenol acrylic acids are metabolized to form their vinylbenzene derivatives was recently documented to be caused by Ferulic Acid Decarboxylase (FDC1). The present disclosure alleviates this issue by providing a potentiating agent designed to sequester the activity of FDC1.

These phenylacrylic acid preservatives also exhibit anti-oxidant properties which may prevent the browning of foodstuffs. Enzymatic browning is caused by polyphenol oxidase (PPO) which oxidize phenol compounds to quinones which are then polymerized to form brown pigments. The phenylacrylic acids presented above may inhibit PPO.

FIG. 2 illustrates an organic compound 200, which is sorbic acid (e.g., 2,4 hexadienoic acid). Sorbic acid is a well-known food preservative, which obtained FDA approval for food both in the US and the EU and (GRAS) in 2015. As will be understood by one of general skill in the art, any soluble sorbic acid salt may be used in accordance with the present disclosure. Typically, the sorbate is the water-soluble salt of sorbic acid. For convenience, the term sorbate used herein to refer to any substance containing the sorbic acid anion, in particular, to denote sorbic acid and its salts thereof. In particular, sodium or potassium sorbate are preferred to be used.

Sorbic acid is a well-known acidulant which kills bacteria and disrupts the membrane potential of mitochondria in fungi which results in the death of the fungi. Sorbic acid is known to be metabolized by fungi to form 1,3 pentadiene, a volatile organic compound which no longer exhibits any antifungal properties. The mechanism by which sorbic acid is metabolized to form 1,3 pentadiene was recently documented to be caused by Ferulic Acid Decarboxylase (FDC1). The present disclosure alleviates this issue by providing a potentiating agent designed to sequester the activity of FDC1.

A potentiating agent, such as (Z)-(2-fluoro-2-nitrovinyl) benzene, increases the efficacy of cinnamate, cinnamate derivatives, ferulate, or sorbate antifungal agents by inhibiting the enzyme instrumental in their breakdown to the inactive form of these antifungal agents which include, 1,3 pentadiene, styrene, styrene derivatives, and vinyl guiacol. These inactive agents have no known role as an antifungal agent. Thus, in at least one embodiment, it may be ideal to prevent the formation of these inactive agents to increase the efficacy of the aforementioned antifungal agents. There is a wide variety of potentiating agents resembling 2,2-Fluoronitrovinylbenzene including, (E)-1-methyl-4-(2-nitrovinyl)benzene, etc. which will also be referred to herein as (E)-(2-nitrovinyl)benzene derivatives. In accordance with the present food preservative solution, these derivatives are equally suited for use in one or more embodiments.

Another suitable potentiating agent may be beta-Nitrostyrene, or associated derivatives. FIG. 3 illustrates an organic compound 300, which is beta-Nitrostyrene or associated derivatives. In various embodiments, the organic compound 300 may include a first organic constituent 302, a second organic constituent 304 and a third organic constituent 306. In one or more embodiments, the first organic constituent 302 may include one or more elements or compounds including, but not limited to: 1) hydrogen; 2) hydroxide (OH); 3) chlorine (e.g., chloride when bonded); 4) fluorine (e.g., fluoride when bonded); and 5) bromine (e.g., bromide when bonded). In at least one embodiment, the second organic constituent 304 may include one or more elements or compounds including, but not limited to: 1) hydrogen; 2) hydroxide (OH); 3) OCH₃; 4) OCH₂CH₃; C1-C10 (e.g., an organic constituent including 1-10 carbon atoms); 6) chlorine (e.g., chloride when bonded); 7) fluorine (e.g., fluoride when bonded); 8) NO₂; 9) CH(CH₃)₂; and 10) C(CH₃)₃. In various embodiments, the third organic constituent 306 may include one or more elements or compounds including, but not limited to: 1) hydrogen; 2) hydroxide (OH); 3) OCH₃; 4) OCH₂CH₃; C1-C10 (e.g., an organic constituent including 1-10 carbon atoms); 6) chlorine (e.g., chloride when bonded); 7) fluorine (e.g., fluoride when bonded); 8) NO₂; 9) CH(CH₃)₂; and 10) C(CH₃)₃.

FIG. 4 illustrates an organic compound 400, which is 2-Nitro-1-phenylethan-1-ol or a derivative. In various embodiments, 2-Nitro-1-phenylethan-1-ol, or associated derivatives may be a suitable potentiating agent for use in the present food preservative solution.

Other potentiating agents (e.g., mandelic acid, 1-nitro-2-phenylethanol, etc.) are naturally occurring and increase the efficacy of cinnamate, cinnamate derivatives, ferulate, or sorbate antimicrobial agents by inhibiting the enzyme instrumental in the breakdown of these antifungal agents to their inactive form, which include 1,3 pentadiene, styrene, styrene derivatives, and vinyl guiacol. These inactive forms generally have no known roles as antifungal agents. Thus, in at least one embodiment, it may be ideal to prevent the formation of these inactive agents to increase the efficacy of the aforementioned antifungal agents. This disclosure places no limitations on the potentiating agents that may be used to inhibit enzymatic breakdown of the antifungal agents.

FIG. 5 illustrates an organic compound 500, which is mandelic acid or a derivative (e.g., all being naturally occurring potentiating agents). In various embodiments, the organic compound 500 may include a first organic constituent 502 and a second organic constituent 504. In one or more embodiments, the first organic constituent 502 may include one or more elements or compounds including, but not limited to: 1) hydrogen; 2) hydroxide (OH); 3) chlorine (e.g., chloride when bonded); 4) fluorine (e.g., fluoride when bonded); and 5) bromine (e.g., bromide when bonded). In at least one embodiment, the second organic constituent 504 may include one or more elements or compounds including, but not limited to: 1) hydrogen; 2) hydroxide (OH); 3) OCH₃; 4) OCH₂CH₃; C1-C10 (e.g., an organic constituent including 1-10 carbon atoms); 6) chlorine (e.g., chloride when bonded); 7) fluorine (e.g., fluoride when bonded); 8) NO₂; 9) CH(CH₃)₂; and 10) C(CH₃)₃.

A food safe stabilizer such as dextrin is designed to enhance the delivery of the formulas to the surface of a wide variety of foodstuffs, and to prevent breakdown of the formulas due to environmental factors like light, heat, and moisture. Dextrin is approved for foodstuffs by both the FDA and the EU and achieved GRAS-status in the US in 1983.

Chitosan has antimicrobial properties specifically for fungi and gram negative bacteria, as well as anti-oxidant properties. Chitosan is approved for foodstuffs both by the FDA and the EU and achieved GRAS-status in the US in 2011

Various embodiments of the present food preservative solution may include sufficient amounts of phenylacrylic acid, and/or ferulic acid, and/or sorbic acid, and the potentiating agent to keep the food free from spoilage, decomposition, or discoloration for at least 5 weeks and at a wide variety of temperatures from about 4 degrees Celsius to about 40 degrees Celsius. Per the present disclosure, the absence of spoilage is noted by absence of any evidence of the growth of spoilage organisms (viable counts, direct microscopic could, or any other standard method of enumeration) and by absence of any discernible change in the food attributes (e.g., that could be routinely attributed to metabolisms of spoilage organisms).

In one or more embodiments, practical application of the present food preservative solution may include a process for extending the useful shelf life of processed foods, which may include treating the foods with a ferulic acid decarboxylase inhibitor as a potentiating agent in combination with ferulic acid decarboxylase susceptible antimicrobial compounds (e.g., such as phenylacrylic acid, ferulic acid, and/or sorbic acid, etc.).

In at least one embodiment, practical application of the present food preservative solution may include a process for extending the useful shelf life of processed foods, which may include treating the foods with a ferulic acid decarboxylase inhibitor as a potentiating agent in combination with ferulic acid decarboxylase susceptible antimicrobial compounds (e.g., cinnamate derivatives, ferulic acid, and/or sorbic acid, etc.).

Another aspect of the present disclosure is an alimentary product, including a sufficient amount of phenylacrylic acid/and or derivatives of, ferulic acid, sorbic acid, and the potentiating agent.

In some embodiments, phenylacrylic acid may be natural, synthetic and/or trans-phenylacrylic acid. In some embodiments, ferulic acid may be natural, synthetic and/or trans-ferulic acid. In various embodiments, sorbic acid may be natural, synthetic and/or trans-sorbic acid. In various embodiments, nitrovinylbenzene is synthetic and/or trans-nitrovinylbenzene. In various embodiments, the potentiating agent is synthetic and/or exists in nature.

Another aspect of the present disclosure is a process wherein foodstuffs are treated with various embodiments of the present food preservative solution with a pH value between 3.0-7.5 pH units.

In various embodiments, the present food preservative solution may include a combination of one or more preservative agents such as trans-sorbic, trans-ferulic, or trans-phenylacrylic acids, a stabilizing agent, and a potentiating agent, which increases the longevity of the aforementioned preservative agents. In one or more embodiments, the preservative agents may disrupt critical metabolic processes for both fungi and bacteria. In at least one embodiment, several of these preservative agents may exhibit antioxidant properties, which could reduce processes (e.g., such as enzymatic browning) that deteriorate the organoleptic properties of foodstuffs.

In various embodiments, the present food preservative solution may combine one or more preservatives with a food safe stabilizer and a potentiating agent to be deployed at multiple phases in the seed to table foodstuff supply chain process. In one or more embodiments, the present solution may be deployed before crops are harvested to prevent disease caused by encountering food pathogens, and may be deployed post-harvest to protect the food during storage and transport to its ultimate destination.

In various embodiments, practical application of the present food preservative solution may include a process wherein foods are sprayed, brushed or immersed in at least one embodiment of the present food preservative solution. In at least one embodiment, the foods are treated with an embodiment of the present food preservative solution containing ferulic acid decarboxylase inhibitor as a potentiating agent in combination with ferulic acid decarboxylase susceptible antimicrobial compounds (e.g., such as phenylacrylic acid, ferulic acid, and/or sorbic acid). In one or more embodiments, the foods (e.g., treated with at least one embodiment of the present solution) may be packaged in suitable packaging for processed food.

FIG. 6A illustrates a flowchart 600A of an exemplary process for applying the present food preservative solution to a product (e.g., a foodstuff) via an immersion method. At step 602A, an operator (e.g., a human or machine performing the immersion method) obtains an uncoated product. At step 604A, the operator immerses the uncoated product in an embodiment of the present food preservative solution for a predetermined period of time. In one or more embodiments, step 604A may be repeated until the uncoated product is sufficiently coated. At step 606A, the operator awaits evaporation of excess food preservative solution from the now-coated product. At step 608A, the operator retrieves the coated product and, in at least one embodiment, sends the coated product to additional processing and packaging operations.

FIG. 6B illustrates a flowchart 600B of an exemplary process for applying the present food preservative solution to a product (e.g., a foodstuff) via an immersion method. At step 602B, an operator (e.g., a human or machine performing the immersion method) obtains an uncoated product. At step 604B, the operator sprays the uncoated product with an embodiment of the present food preservative solution for a predetermined period of time. In one or more embodiments, step 604B may be repeated until the uncoated product is sufficiently coated. At step 606B, the operator retrieves the coated product and, in at least one embodiment, sends the coated product to additional processing and packaging operations.

FIG. 6C illustrates a flowchart 600C of an exemplary process for applying the present food preservative solution to a product (e.g., a foodstuff) via an immersion method. At step 602C, an operator (e.g., a human or machine performing the immersion method) obtains an uncoated product. At step 604C, the operator sprays the uncoated product with an embodiment of the present food preservative solution for a predetermined period of time. In one or more embodiments, step 604C may be repeated until the uncoated product is sufficiently coated. At step 606C, the operator retrieves the coated product and, in at least one embodiment, sends the coated product to additional processing and packaging operations.

### ADDITIONAL DESCRIPTION OF VARIOUS EMBODIMENTS AND EXPERIMENTAL RESULTS

The following section describes one or more experimental tests, and results thereof, performed on one or more embodiments of the present preservative system. The descriptions therein are provided for the purposes of illustrating various elements of the preservative system (e.g., as observed in the one or more embodiments). All descriptions, embodiments, and the like are exemplary in nature and place no limitations on any embodiment described, or anticipated, herein or otherwise.

### Experimental Test 1

All tests and formulations were conducted at a KLF Labs facility currently located in Blue Ridge, Ga. All chemical materials were provided by Sigma Aldrich (St. Louis, Mo.), Fisher Scientific (Hampton, N.H.) and SpiroChem (Basel, Switzerland). Exemplary formulations of the present food preservative solution are found in Tables 1, 2, 3, 4, 5, 6, 7 and 8 below.

TABLE 1
Exemplary formula for 1 L food preservative solution.

| Component | Mass (mg) | Weight percent (w/v)% |
|---|---|---|
| Trans-Phenylacrylic Acid | 100-500 mg | 0.01-0.05 |
| 2,2 fluoronitrovinylbenzene | 10-20 mg | 0.001-0.002 |
| Chitosan | 0-5000 mg | 0.0-0.5 |

TABLE 2
Exemplary formula for 1 L food preservative solution.

| Component | Mass (mg) | Weight percent (w/v)% |
|---|---|---|
| Trans-Sorbic Acid | 100-300 mg | 0.01-0.05 |
| 2,2 fluoronitrovinylbenzene | 10-20 mg | 0.001-0.002 |
| Chitosan | 100-5000 mg | 0.0-0.5 |

TABLE 3
Exemplary formula for 1 L food preservative solution.

| Component | Mass (mg) | Weight percent (w/v) % |
|---|---|---|
| Trans-Ferulic Acid | 0-500 mg | 0.01-0.05 |
| 2,2 fluoronitrovinylbenzene | 10-20 mg | 0.001-0.002 |
| Chitosan | 100-5000 mg | 0.01-0.5 |

TABLE 4
Exemplary formula for 1 L food preservative solution.

| Component | Mass (mg) | Weight percent (w/v) % |
|---|---|---|
| Trans-Ferulic Acid | 100-500 mg | 0.01-0.05 |
| 2,2 fluoronitrovinylbenzene | 10-20 mg | 0.001-0.002 |
| Chitosan | 100-500 mg | 0.01-0.05 |
| Trans-Phenylacrylic Acid | 100-5000 mg | 0.01-0.5 |

TABLE 5
Exemplary formula for 1 L food preservative solution.

| Component | Mass (mg) | Weight percent (w/v) % |
|---|---|---|
| Trans-Sorbic Acid | 100-500 mg | 0.01-0.05% |
| 2,2 fluoronitrovinylbenzene | 10-20 mg | 0.001-0.002% |
| Chitosan | 100-5000 mg | 0.01-0.5% |
| Trans-Phenylacrylic Acid | 100-500 mg | 0.01-0.05% |

TABLE 6
Exemplary formula for 1 L food preservative solution.

| Component | Mass (mg) | Weight percent (w/v) % |
|---|---|---|
| Trans-Sorbic Acid | 100-500 mg | 0.01-0.05 |
| 2,2 fluoronitrovinylbenzene | 10-20 mg | 0.001-0.002 |
| Chitosan | 0-5000 mg | 0.01-0.5 |
| Trans-Ferulic Acid | 100-500 mg | 0.01-0.05 |

TABLE 7
Exemplary formula for 1 L food preservative solution.

| Component | Mass (mg) | Weight percent (w/v) % |
|---|---|---|
| Trans-Sorbic Acid | 100-500 mg | 0.01-0.05 |
| 2,2 fluoronitrovinylbenzene | 10-20 mg | 0.001-0.002 |
| Chitosan | 100-5000 mg | 0.01-0.5 |
| Trans-Phenylacrylic Acid | 100-500 mg | 0.01-0.05 |
| Trans-Ferulic Acid | 100-500 mg | 0.01-0.05 |

TABLE 8
Exemplary formula for 1 L food preservative solution.

| Component | Mass (mg) | Weight percent (w/v) % |
|---|---|---|
| Trans-Sorbic Acid | 100-500 mg | 0.01-0.05 |
| L/D-Mandelic Acid | 100-500 mg | 0.01-0.05 |
| Chitosan | 0-5000 mg | 0.0-0.5 |
| Trans-Phenylacrylic Acid | 0-500 mg | 0.0-0.05 |
| Trans-Ferulic Acid | 0-500 mg | 0.0-0.05 |

In various embodiments, the present food preservative solution may include phenylacrylic acid which may contain 85%-90% by weight of the preservative with 5%-10% by weight of the potentiating agent or 2,2-nitrovinylbenzene derivative and 5% Dextrin, Chitosan or associated stabilizer.

In one or more embodiments, the present food preservative solution may include (e.g., in combination), but is not limited to: 1) sorbic acid (e.g., forming 85%-90% by weight of the preservative solution); 2) a potentiating agent, such as 2, 2-nitrovinylbenzene derivative (e.g., forming 5%-10% by weight of the preservative solution); and 3) Dextrin, Chitosan or associated stabilizer (e.g., forming 5% by weight of the preservative solution).

In at least one embodiment, the present food preservative solution may include ferulic acid which may contain 85%-90% by weight of the preservative with 5%-10% by weight of the potentiating agent or nitrovinylbenzene derivative and 5% by weight Dextrin, Chitosan or associated stabilizer.

In various embodiments, the preservative solution may include a mixture of phenylacrylic, ferulic acids and the potentiating agent. In one or more embodiments, the ferulic acid may contain between 5%-82.5% by weight. In at least one embodiment, the phenylacrylic acid may contain between 5%-82.5% by weight. In various embodiments, the potentiating agent or associated 2-nitrovinylbenzene derivative may contain between 5%-10% by weight and 5% by weight Dextrin, Chitosan or associated stabilizer.

In one or more embodiments, the preservative solution may include a mixture of sorbic acid, phenylacrylic acid, and the potentiating agent. In at least one embodiment, the phenylacrylic acid may contain between 5%-82.5% by weight. In various embodiments, the sorbic acid may contain between 5%-82.5% by weight. In one or more embodiments, the potentiating agent or associated 2-nitrovinylbenzene derivative may contain between 5%-10% by weight and 5% by weight Dextrin, Chitosan or associated stabilizer.

In at least one embodiment, the preservative solution may include a mixture of sorbic acid, ferulic acid, and the potentiating agent. In various embodiments, the ferulic acid may contain between 5%-82.5% by weight. In one or more embodiments, the sorbic acid may contain between 5%-82.5% by weight. In at least one embodiment, the potentiating agent or associated 2-nitrovinylbenzene derivative may contain between 5%-10% by weight and 5% by weight Dextrin, Chitosan or associated stabilizer.

In various embodiments, the preservative solution may include a mixture of phenylacrylic, ferulic acid, sorbic acid, and the potentiating agent. In one or more embodiments, the ferulic acid may contain between 5%-70% by weight. In at least one embodiment, the phenylacrylic acid may contain between 5%-70% by weight. In various embodiments, the sorbic acid may contain between 5%-70% by weight. In one or more embodiments, the potentiating agent or associated 2-nitrovinylbenzene derivative may contain between 5%-10% by weight and 5% Dextrin, Chitosan or associated stabilizer by weight.

In at least one embodiment, the preservative solution may include phenylacrylic, ferulic, and/or sorbic acid and the potentiating agent. In various embodiments, the preservative solution may include 5%-47.5% by weight phenylacrylic acid, mandelic acid or similar potentiating agent and 5% by weight Dextrin, Chitosan or associated stabilizer. In one or more embodiments, the preservative solution may include 5%-47.5% by weight sorbic acid, mandelic acid or similar potentiating agent and 5% by weight Dextrin, Chitosan or associated stabilizer.

In various embodiments, the preservative solution may include between 8.3%-10% by weight of phenylacrylic acid or associated organic acid, 1%-10% by weight of mandelic acid and 80%-81.7% of chitosan or associated stabilizer.

In various embodiments, the delivery method for the above disclosures may include, but is not limited to: 1) dissolving the robust preservative solutions in water and adjusting the pH between 3.0-7.5 pH units; and 2) dissolving the dry homogenized components of the preservative solution in water followed by adjusting the pH between 3.0-7.5 pH units.

In the various embodiments for liquid and semi-liquid solutions such as beverages, the liquid or semi-liquid solution may contain between 0-500 ppm of phenylacrylic acid and 0-200 ppm of the potentiating agent. Other examples of liquid and semi-liquid solutions include, but are not limited to: 1) syrups; 2) condiments; 3) sauces; 4) yogurt, or the like; 5) jams; 6) jellies; and 7) frosting. In various embodiments, the beverage may contain the smallest amount of materials necessary to prevent microbial spoilage.

In various embodiments for the liquid systems such as beverages the beverage may be between 0-500 ppm phenylacrylic acid, 0-500 ppm of ferulic acid, and 0-5000 ppm of the potentiating agent but may contain the adequate amount to prevent microbial spoilage.

### Experimental Test 2

The effectiveness of the present disclosure's combination of a preserving and potentiating agent in controlling the growth and development of microorganisms responsible for the deterioration of food products is exemplified by the below results obtained in the following in vitro tests with a strain of Saccharomyces cerevisiae, a common yeast and one of the most commonly used model organisms for fungi.

In conducting tests with Saccharomyces cerevisiae, 1 L of a growth medium was first prepared having the following composition as indicated in Table 9.

TABLE 9
Exemplary formulation of growth medium.

| Substance | Grams/Liter of Water |
|---|---|
| Asparagine monohydrate | 5.000 g |
| Glucose | 10.000 g |
| MgSO₄•7H₂O | 0.250 g |
| KH₂PO₄ | 0.250 g |
| FeSO₄•7H₂O | 0.001 g |

Each of the formulations presented above was added to each of the three 20 mL samples of the agar medium.

In connection with this particular experiment, the pH of the samples was adjusted to a pH value of 4.0 by adding a small amount of 0.1 M HCl. The samples were then sterilized with steam at 121° C. for 15 minutes. In one embodiment, 1 mL sample formulations were poured into a 1.5 mL sterile microcentrifuge tube and inoculated with ˜10,000 Saccharomyces cerevisiae cells (e.g., yeast cells). The cells were allowed to grow outwards for 72 hours and then the endpoint concentration of cell growth was determined spectrophotometrically at 660 nm. In samples where cell growth was generally absent cell samples were diluted and counted on a yeast extract peptone dextrose plate. A general average value of yeast cell data for each of presented solutions is presented in Table 10. Controls to account for the presence of binder in the absorbance reading were subtracted out in the reporting of the final absorbance. The negative control was diluted twenty times prior to reading the Abs 660 nm.

TABLE 10
Cell counts of Saccharomyces cerevisiae after application of
Fungal Firewall ™ formulation. “Fungal Firewall ™,”
refers to one commercial/market name for the formulations
presented and described in this disclosure.

| | Abs 660 nm after | Cell Count after 3 days |
|---|---|---|
| Formula | 3 days | (CFU/mL) |
| 1000 ppm Potassium Sorbate | 0.0396 ± 0.005 | 5.3 × 10⁵ |
| 500 ppm Potassium Sorbate | 0.02679 ± 0.003 | 3.4 × 10⁵ |
| 300 ppm Mandelic Acid | | |
| 500 ppm Potassium Sorbate | 0.0349 ± 0.004 | 4.7 × 10⁵ |
| 400 ppm Mandelic Acid | | |
| 500 ppm Potassium Sorbate | 0.0240 ± 0.003 | 3.2 × 10⁵ |
| 500 ppm Mandelic Acid | | |
| 500 ppm Phenylacrylic Acid | 0.0104 ± 0.005 | 1.5 × 10⁵ |
| 5000 ppm Chitosan | | |
| 500 ppm Mandelic Acid | | |
| 250 ppm Sorbic Acid | 0.00834 ± 0.002 | 1.2 × 10⁵ |
| 5000 ppm Chitosan | | |
| 500 ppm Mandelic Acid | | |
| 500 ppm Phenylacrylic Acid | 0.0407 ± 0.005 | 4.8 × 10⁵ |
| 1000 ppm Chitosan | | |
| 500 ppm Mandelic Acid | | |
| 250 ppm Sorbic Acid | 0.0435 ± 0.006 | 5.5 × 10⁵ |
| 500 ppm Mandelic Acid | | |
| 5000 ppm Chitosan | | |
| pH control | 0.889 ± 0.3 | 6.8 × 10⁸ |

In relation with this experiment, the data shows that yeast growth was generally slowed over the positive control, Potassium Sorbate, out to 3 days. Generally, the formulations presented all exhibited increased efficacy over the positive control.

### Experimental Test 3

This exemplary test example depicts of how the preservative compositions of this disclosure may substantially increase the pH operating range of conventional organic acid preservatives such as sorbic acid, phenylacrylic acid, and ferulic acid against common fungal species including; Saccharomyces cerevisiae, Candida parapsilosis, Zygosaccharomyces rouxii, and Zygosaccharomyces bailii. In these experiments 1 L of growth media was prepared with the concentrations indicated in Table 11.

TABLE 11
Exemplary formulation of growth media.

| Ingredient | Mass (g) |
|---|---|
| Water | 1000 g |
| Potatoes (sliced | 4 g |
| washed unpeeled) | |
| Dextrose | 20 g |
| Agar powder | 20 g |

The media was then sterilized by steam autoclaving the solution for 15 minutes at 121° C. and the media was placed into 3 96 cell plates and pH using either 0.1N HCl or 0.1N NaOH to pH values of 3.1, 5.6, 6.0, 6.5, 7.0, and 7.5.

Three exemplary embodiment solutions were added and serial diluted into a series of treatment wells and 0.5 McFarland Standard's worth of yeast cells were added to each well. The plates were incubated at 32° C. for 48 hours and then the OD was read at 600 nm. The percent inhibition was graphed as a percentage of the following formula indicated in Equation 1.

$$\% Inhibition = ( 1 - \frac{{OD}_{experimental}}{{OD}_{positive control }} ) * 100 \qquad ( Equation 1 )$$

In relation with this experiment, the data indicated in Tables 12-15 demonstrate that the yeast growth was slowed upon the addition of any of the mentioned antimicrobials, however the addition of mandelic acid generally increased the efficacy of potassium sorbate by between 2-10× and increased the pH range in which potassium sorbate could generate complete suppression of certain yeast species. This effect was also generally observed when phenylacrylic acid was potentiated with the mandelic acid and provided increased efficacy over the potassium sorbate positive control.

The addition of chitosan to the phenylacrylic acid, mandelic acid mixture greatly improved the pH range and efficacy of the phenylacrylic acid/mandelic acid solution, by providing a greater suppression at lower concentrations of both phenylacrylic acid and mandelic acid.

TABLE 12
Percent inhibition of different microbes by different levels
of potassium sorbate and between pH values of 3.1-7.5.

| | pH 3.1 | pH 5.6 | pH 6.0 | pH 6.5 | pH 7.0 | pH 7.5 |
|---|---|---|---|---|---|---|
| Saccharomyces cerevisiae | | | | | | |
| Potassium Sorbate 2000 ppm | 99.30% | 99.40% | 76.20% | 84.60% | 84.90% | 72.10% |
| Potassium Sorbate 1000 ppm | 99.80% | 99% | 62% | 60.60% | 69% | 73.60% |
| Potassium Sorbate 500 ppm | 99.70% | 98.10% | 50.30% | 48.10% | 53.20% | 55.80% |
| Potassium Sorbate 250 ppm | 99.40% | 95.30% | 25% | 28.20% | 37.90% | 44.90% |
| Potassium Sorbate 130 ppm | 99.60% | 84.90% | 9.90% | 17.70% | 22% | 19.40% |
| Candida parapsilosis | | | | | | |
| Potassium Sorbate 2000 ppm | 6.50% | 42.40% | 2.80% | 0.80% | 8.40% | 7.40% |
| Potassium Sorbate 1000 ppm | 13.50% | 32.80% | 4.60% | 0% | 8.30% | 0% |
| Potassium Sorbate 500 ppm | 16.20% | 28.70% | 7.60% | 0% | 15.90% | 0% |
| Potassium Sorbate 250 ppm | 5.20% | 12.30% | 12.80% | 1.10% | 8.80% | 0% |
| Potassium Sorbate 130 ppm | 0.90% | 9.50% | 5% | 3.30% | 1.70% | 6.20% |
| Zygosaccharomyces rouxii | | | | | | |
| Potassium Sorbate 2000 ppm | 84.20% | 100% | 63.30% | 90.60% | 89.30% | 95.20% |
| Potassium Sorbate 1000 ppm | 88.60% | 99.30% | 17.40% | 65.60% | 86.20% | 74.90% |
| Potassium Sorbate 500 ppm | 80.40% | 37.70% | 3.40% | 6.70% | 62.70% | 48.60% |
| Potassium Sorbate 250 ppm | 66.70% | 95.90% | 0% | 0% | 9.20% | 16.50% |
| Potassium Sorbate 130 ppm | 39.30% | 93.70% | 0% | 19.70% | 4.70% | 7.20% |
| Zygosaccharomyces bailii | | | | | | |
| Potassium Sorbate 2000 ppm | 100% | 99.80% | 3% | 20% | 16% | 0.30% |
| Potassium Sorbate 1000 ppm | 99.70% | 99.70% | 1.80% | 0% | 0% | 0% |
| Potassium Sorbate 500 ppm | 99.10% | 95.60% | 0% | 0% | 0% | 0% |
| Potassium Sorbate 250 ppm | 96.50% | 86.70% | 0% | 0% | 0% | 0% |
| Potassium Sorbate 130 ppm | 91.90% | 70.40% | 0% | 0% | 0% | 9.70% |

TABLE 13
Percent inhibition of different levels of microbes by a first plurality of embodiments
of the present food preservative solution and between pH values of 3.1-7.5.

| | pH 3.1 | pH 5.6 | pH 6.0 | pH 6.5 | pH 7.0 | pH 7.5 |
|---|---|---|---|---|---|---|
| Saccharomyces cerevisiae | | | | | | |
| 1000 ppm Phenylacrylic Acid | 99.60% | 99.80% | 99.40% | 98.50% | 92.80% | 81% |
| 1000 ppm Mandelic Acid | | | | | | |
| 500 ppm Phenylacrylic Acid | 98.80% | 99.50% | 43.50% | 14.70% | 0% | 0% |
| 500 ppm Mandelic Acid | | | | | | |
| 250 ppm Phenylacrylic Acid | 99.30% | 55.50% | 1% | 0% | 0% | 0% |
| 250 ppm Mandelic Acid | | | | | | |
| 125 ppm Phenylacrylic Acid | 63% | 0% | 0% | 0% | 0% | 0% |
| 125 ppm Mandelic Acid | | | | | | |
| 62.5 ppm Phenylacrylic Acid | 1.70% | 0% | 0% | 0% | 0% | 0% |
| 62.5 ppm Mandelic Acid | | | | | | |
| Candida parapsilosis | | | | | | |
| 1000 ppm Phenylacrylic Acid | 99.50% | 99.60% | 89.50% | 85.10% | 89.30% | 95.20% |
| 1000 ppm Mandelic Acid | | | | | | |
| 500 ppm Phenylacrylic Acid | 98.70% | 94.50% | 30% | 20.20% | 86.20% | 74.90% |
| 500 ppm Mandelic Acid | | | | | | |
| 250 ppm Phenylacrylic Acid | 99.20% | 53.40% | 12% | 4.90% | 62.70% | 48.60% |
| 250 ppm Mandelic Acid | | | | | | |
| 125 ppm Phenylacrylic Acid | 92.40% | 21.50% | 11.50% | 1.40% | 9.20% | 16.50% |
| 125 ppm Mandelic Acid | | | | | | |
| 62.5 ppm Phenylacrylic Acid | 77.80% | 5.80% | 5% | 3.30% | 2.50% | 0% |
| 62.5 ppm Mandelic Acid | | | | | | |
| Zygosaccharomyces rouxii | | | | | | |
| 1000 ppm Phenylacrylic Acid | 92.10% | 99.70% | 90.90% | 85.80% | 72.50% | 64.60% |
| 1000 ppm Mandelic Acid | | | | | | |
| 500 ppm Phenylacrylic Acid | 90.90% | 99% | 17.60% | 13.70% | 9.30% | 9.20% |
| 500 ppm Mandelic Acid | | | | | | |
| 250 ppm Phenylacrylic Acid | 93.50% | 38.30% | 5% | 0% | 1.80% | 0% |
| 250 ppm Mandelic Acid | | | | | | |
| 125 ppm Phenylacrylic Acid | 88.90% | 0% | 0% | 0% | 0% | 0% |
| 125 ppm Mandelic Acid | | | | | | |
| 62.5 ppm Phenylacrylic Acid | 44.60% | 0% | 0% | 0% | 21.70% | 7.30% |
| 62.5 ppm Mandelic Acid | | | | | | |
| Zygosaccharomyces bailii | | | | | | |
| 1000 ppm Phenylacrylic Acid | 100% | 99.80% | 15.50% | 23.10% | 16% | 0.30% |
| 1000 ppm Mandelic Acid | | | | | | |
| 500 ppm Phenylacrylic Acid | 99.60% | 77.90% | 3% | 9% | 0% | 0% |
| 500 ppm Mandelic Acid | | | | | | |
| 250 ppm Phenylacrylic Acid | 91% | 10.50% | 0% | 0% | 0% | 0% |
| 250 ppm Mandelic Acid | | | | | | |
| 125 ppm Phenylacrylic Acid | 57.30% | 7.70% | 0% | 0% | 0% | 0% |
| 125 ppm Mandelic Acid | | | | | | |
| 62.5 ppm Phenylacrylic Acid | 27.30% | 0% | 0% | 0% | 0% | 9.70% |
| 62.5 ppm Mandelic Acid | | | | | | |

TABLE 14
Percent inhibition of different levels of microbes by a second plurality of embodiments
of the present food preservative solution and between pH values of 3.1-7.5.

| | pH 3.1 | pH 5.6 | pH 6.0 | pH 6.5 | pH 7.0 | pH 7.5 |
|---|---|---|---|---|---|---|
| Saccharomyces cerevisiae | | | | | | |
| 2000 ppm Chitosan | 99.60% | 99.80% | 96% | 98.40% | 99.10% | 97.40% |
| 200 ppm Phenylacrylic Acid | | | | | | |
| 200 ppm Mandelic Acid | | | | | | |
| 1000 ppm Chitosan | 98.80% | 99.50% | 97.70% | 99% | 100% | 100% |
| 100 ppm Phenylacrylic Acid | | | | | | |
| 100 ppm Mandelic Acid | | | | | | |
| 500 ppm Chitosan | 99.30% | 55.50% | 97.50% | 98.70% | 98.40% | 99.80% |
| 50 ppm Phenylacrylic Acid | | | | | | |
| 50 ppm Mandelic Acid | | | | | | |
| 250 ppm Chitosan | 63% | 0% | 98.80% | 97.50% | 98.80% | 98.60% |
| 25 ppm Phenylacrylic Acid | | | | | | |
| 25 ppm Mandelic Acid | | | | | | |
| 125 ppm Chitosan | 1.70% | 0% | 99.30% | 98.70% | 100% | 94.80% |
| 12.5 ppm Phenylacrylic Acid | | | | | | |
| 12.5 ppm Mandelic Acid | | | | | | |
| Candida parapsilosis | | | | | | |
| 2000 ppm Chitosan | 100.30% | 97.30% | 100% | 100% | 100% | 100% |
| 200 Phenylacrylic Acid | | | | | | |
| 200 ppm Mandelic Acid | | | | | | |
| 1000 ppm Chitosan | 99.60% | 91.30% | 100% | 100% | 99.30% | 96.60% |
| 100 Phenylacrylic Acid | | | | | | |
| 100 ppm Mandelic Acid | | | | | | |
| 500 ppm Chitosan | 99.80% | 98% | 99.70% | 100% | 98.20% | 99.40% |
| 50 ppm Phenylacrylic Acid | | | | | | |
| 50 ppm Mandelic Acid | | | | | | |
| 250 ppm Chitosan | 99.60% | 82.80% | 100% | 100% | 100% | 97.70% |
| 25 ppm Phenylacrylic Acid | | | | | | |
| 25 ppm Mandelic Acid | | | | | | |
| 125 ppm Chitosan | 58% | 13% | 19.30% | 49.10% | 71.40% | 84% |
| 12.5 ppm Phenylacrylic Acid | | | | | | |
| 12.5 ppm Mandelic Acid | | | | | | |
| Zygosaccharomyces rouxii | | | | | | |
| 2000 ppm Chitosan | 100% | 95.70% | 100% | 98% | 98.70% | 99.10% |
| 200 ppm Phenylacrylic Acid | | | | | | |
| 200 ppm Mandelic Acid | | | | | | |
| 1000 ppm Chitosan | 95.50% | 84.10% | 99.60% | 99.30% | 99.50% | 99.30% |
| 100 ppm Phenylacrylic Acid | | | | | | |
| 100 ppm Mandelic Acid | | | | | | |
| 500 ppm Chitosan | 78.30% | 71% | 100% | 98% | 98.80% | 99.10% |
| 50 ppm Phenylacrylic Acid | | | | | | |
| 50 ppm Mandelic Acid | | | | | | |
| 250 ppm Chitosan | 37% | 72.20% | 100% | 98.10% | 100% | 99.30% |
| 25 ppm Phenylacrylic Acid | | | | | | |
| 25 ppm Mandelic Acid | | | | | | |
| 125 ppm Chitosan | 0% | 80.10% | 100% | 99.20% | 99.90% | 99.10% |
| 12.5 ppm Phenylacrylic Acid | | | | | | |
| 12.5 ppm Mandelic Acid | | | | | | |
| Zygosaccharomyces bailii | | | | | | |
| 2000 ppm Chitosan | 100.40% | 98.30% | 100% | 98% | 100% | 99.70% |
| 200 ppm Phenylacrylic Acid | | | | | | |
| 200 ppm Mandelic Acid | | | | | | |
| 1000 ppm Chitosan | 99.90% | 96.10% | 99.60% | 99.30% | 98.50% | 99.10% |
| 100 ppm Phenylacrylic Acid | | | | | | |
| 100 ppm Mandelic Acid | | | | | | |
| 500 ppm Chitosan | 91% | 95.10% | 100% | 98% | 98.90% | 99.50% |
| 50 ppm Phenylacrylic Acid | | | | | | |
| 50 ppm Mandelic Acid | | | | | | |
| 250 ppm Chitosan | 57.30% | 90.20% | 100% | 98.10% | 95.20% | 98.50% |
| 25 ppm Phenylacrylic Acid | | | | | | |
| 25 ppm Mandelic Acid | | | | | | |
| 125 ppm Chitosan | 27.30% | 97.50% | 100% | 99.20% | 100% | 99.90% |
| 12.5 ppm Phenylacrylic Acid | | | | | | |
| 12.5 ppm Mandelic Acid | | | | | | |

TABLE 15
Percent inhibition of different levels of microbes by a second plurality of embodiments
of the present food preservative solution and between pH values of 3.1-7.5.

| | pH 3.1 | pH 5.6 | pH 6.0 | pH 6.5 | pH 7.0 | pH 7.5 |
|---|---|---|---|---|---|---|
| Saccharomyces cerevisiae | | | | | | |
| 1000 ppm Sorbic Acid | 98.20% | 99% | 99.30% | 99% | 99.40% | 98.90% |
| 1000 ppm Mandelic Acid | | | | | | |
| 500 ppm Sorbic Acid | 99.30% | 99.90% | 86.70% | 74% | 72.50% | 58.20% |
| 500 ppm Mandelic Acid | | | | | | |
| 250 ppm Sorbic Acid | 99.30% | 96.90% | 35.40% | 0% | 0% | 0% |
| 250 ppm Mandelic Acid | | | | | | |
| 125 ppm Sorbic Acid | 57.30% | 46.90% | 0% | 0% | 0% | 0% |
| 125 ppm Mandelic Acid | | | | | | |
| 62.5 ppm Sorbic Acid | 11.60% | 8.70% | 0% | 0% | 0% | 0% |
| 62.5 ppm Mandelic Acid | | | | | | |
| Candida parapsilosis | | | | | | |
| 1000 ppm Sorbic Acid | 99.20% | 98.30% | 98.80% | 98.90% | 100% | 98.70% |
| 1000 ppm Mandelic Acid | | | | | | |
| 500 ppm Sorbic Acid | 99.10% | 99.30% | 76.20% | 66.80% | 68% | 49.50% |
| 500 ppm Mandelic Acid | | | | | | |
| 250 ppm Sorbic Acid | 100% | 95.60% | 32.30% | 17.80% | 10.50% | 0% |
| 250 ppm Mandelic Acid | | | | | | |
| 125 ppm Sorbic Acid | 99.60% | 51.20% | 18.80% | 0% | 2.70% | 0% |
| 125 ppm Mandelic Acid | | | | | | |
| 62.5 ppm Sorbic Acid | 88.70% | 25.40% | 3.90% | 0% | 6.40% | 0% |
| 62.5 ppm Mandelic Acid | | | | | | |
| Zygosaccharomyces rouxii | | | | | | |
| 1000 ppm Sorbic Acid | 89.50% | 98.50% | 99.50% | 99.80% | 99.80% | 99.70% |
| 1000 ppm Mandelic Acid | | | | | | |
| 500 ppm Sorbic Acid | 93.20% | 99.30% | 82.40% | 84.10% | 56.90% | 23.20% |
| 500 ppm Mandelic Acid | | | | | | |
| 250 ppm Sorbic Acid | 97.80% | 94.90% | 12.10% | 0% | 7.50% | 0% |
| 250 ppm Mandelic Acid | | | | | | |
| 125 ppm Sorbic Acid | 100% | 27.80% | 0% | 0% | 0% | 0% |
| 125 ppm Mandelic Acid | | | | | | |
| 62.5 ppm Sorbic Acid | 73.20% | 0% | 0% | 0% | 0% | 2.70% |
| 62.5 ppm Mandelic Acid | | | | | | |
| Zygosaccharomyces bailii | | | | | | |
| 1000 ppm Sorbic Acid | 100.00% | 99.80% | 49.60% | 46.40% | 48.30% | 35.60% |
| 1000 ppm Mandelic Acid | | | | | | |
| 500 ppm Sorbic Acid | 99.60% | 77.90% | 18.30% | 18.30% | 1.40% | 0% |
| 500 ppm Mandelic Acid | | | | | | |
| 250 ppm Sorbic Acid | 91% | 10.50% | 6.40% | 5.80% | 8.60% | 0% |
| 250 ppm Mandelic Acid | | | | | | |
| 125 ppm Sorbic Acid | 57.30% | 7.70% | 3.80% | 1.60% | 0% | 0% |
| 125 ppm Mandelic Acid | | | | | | |
| 62.5 ppm Sorbic Acid | 27.30% | 0% | 1.50% | 0.70% | 0% | 0% |
| 62.5 ppm Mandelic Acid | | | | | | |

### Experimental Test 4

The effectiveness of the disclosure's combination of a preserving and potentiating agent in controlling the growth and development of microorganisms responsible for the deterioration of foodstuffs is exemplified by the results obtained in the following in vitro tests with a strain of Lactobacillus acidolphus, one of the most commonly used model organisms for gram positive, and Escherichia coli one of the most commonly used model organisms for gram negative bacteria.

In conducting tests with the model organisms, agar medium for 1 L plates were first prepared having the composition indicated in Table 16.

TABLE 16
Exemplary formulation of growth media.

| Substance | Grams/Liter of Water |
|---|---|
| Asparagine monohydrate | 5.000 g |
| Glucose | 10.000 g |
| MgSO₄•7H₂O | 0.250 g |
| KH₂PO₄ | 0.250 g |
| FeSO₄•7H₂O | 0.001 g |

In connection with this particular experiment, the pH of the samples was adjusted to a pH value of 4.5 by adding a small amount of 0.1 M HCl. The samples were then sterilized with steam at 121° C. for about 15 minutes. The formulations were allowed to cool to 70° F., after which a sample of 10⁶ cells of an aforementioned microorganism, as measured using the optical density of the cells, was applied to 1 mL of the individual solutions. Afterwards, samples were allowed to grow for 24 hours. The solutions were diluted one hundred-fold and 10 microliters were applied to a LB media plate and outgrown for 24 additional hours. The Lactobacillus acidophilus exhibited no initial outgrowth so 10 microliters of the experiment were directly plated onto LB plates. The cells on the plates were counted and the results are displayed Table 17.

TABLE 17
Cell count of Lactobacillus acidophilus and Escherichia coli
upon the application of the formulations.

| | Escherichia | Lactobacillus |
|---|---|---|
| | coli cell | acidophilus |
| | count | cell count |
| Formula | Log(CFU/mL) | Log(CFU/mL) |
| 500 ppm Potassium Sorbate | 5.49 | <2 |
| 500 ppm Potassium Sorbate | 1.0 | <2 |
| 300 ppm Mandelic Acid | | |
| 500 ppm Potassium Sorbate | 1.0 | <2 |
| 400 ppm Mandelic Acid | | |
| 500 ppm Potassium Sorbate | 4.84 | <2 |
| 500 ppm Mandelic Acid | | |
| 500 ppm Phenylacrylic Acid | 1.0 | <2 |
| 5000 ppm Chitosan | | |
| 500 ppm Mandelic Acid | | |
| 250 ppm Sorbic Acid | 1.0 | <2 |
| 5000 ppm Chitosan | | |
| 500 ppm Mandelic Acid | | |
| 500 ppm Phenylacrylic Acid | 4.48 | <2 |
| 1000 ppm Chitosan | | |
| 500 ppm Mandelic Acid | | |
| 250 ppm Sorbic Acid | 4.9 | <2 |
| 500 ppm Mandelic Acid | | |
| 5000 ppm Chitosan | | |
| pH control | 7.19 | 4.13 |

In relation to this experiment, the formulations generally exhibited more significant decreases in gram negative and gram positive bacteria over pH control alone and common antifungal and antibacterial agent trans-sorbic acid. Formulation example 1, 2, 4 and 5 generally exhibited over 100% increase in the end point cell count reduction over the industry control of 1000 ppm sorbic acid.

### Experimental Test 5

The efficacy of the formulations presented in Tables 1-7 for preserving beverages against yeast was screened in a model beverage. Application experiments were set up using a model beverage. The formulations were tested against Saccharomyces cerevisiae, a yeast well recognized for its beverage spoiling quality. A sterile model beverage was prepared using the formulation indicated in Table 19, with an initial inoculation quantity of 10⁴ cells/mL of beverage.

TABLE 19
Exemplary formulation of sterile model beverage.

| Substance | Grams/Liter of Water |
|---|---|
| Water | 965.000 g |
| Citric Acid | 2.200 g |
| Sucrose | 40.000 g |
| Flavor | 0.350 g |
| Apple Juice | 8.280 g |
| Concentrate | |

In connection with this particular experiment, once the sterile beverage was prepared, the formulations in Table 20 were added to samples of the sterile sample beverage up to 0.05% w/v. The OD 660 of each sample was measured 72 hours after initial inoculation using an 8543 Spectrophotometer and the data was compiled using excel, as depicted in Table 20.

TABLE 20
OD 660 nm measurements recording cell growth after 72 hours in
the model beverage at 4° C. after the formulations are applied.

| Formula | OD 660 nm |
|---|---|
| 300 ppm Phenylacrylic Acid | 0.51 |
| 100 ppm Phenylacrylic Acid | 0.11 |
| 400 ppm Mandelic Acid | |
| 250 ppm Sorbic Acid | 0.05 |
| 250 ppm Mandelic Acid | |
| 250 ppm Chitosan | 0.04 |
| 50 ppm Phenylacrylic Acid | |
| 20 ppm 1,2 nitro-phenolethanol | |
| 250 ppm Chitosan | 0.08 |
| 50 ppm Phenylacrylic Acid | |
| 50 ppm Mandelic Acid | |
| 250 ppm Phenylacrylic Acid | 0.08 |
| 250 ppm Mandelic Acid | |
| 200 ppm Sorbic Acid | 0.07 |
| 300 ppm Mandelic Acid | |
| 250 ppm Chitosan | 0.04 |
| 50 ppm Sorbic acid | |
| 50 ppm Mandelic Acid | |
| 300 ppm Phenylacrylic Acid | 0.15 |
| 200 ppm Mandelic Acid | |

In relation to this experiment, the formulations of Table 20, generally managed to suppress the growth of Saccharomyces cerevisiae as showcased by the lack of OD 660 nm versus the 200 ppm phenylacrylic acid positive control. This lack of growth may be due to the sustained presence of the antifungal components in juice. As can be inferred for these results, the model drinks containing the formulations were protected against yeast spoilage.

### Experimental Test 6

To determine ascertain bactericidal and fungicidal qualities of the present food preservative solution, certain embodiments containing a combination of phenylacrylic acid, sorbic acid, a potentiation agent and a stabilization agent were subjected to a modified version of the United States Pharmocopedia (USP) antimicrobial efficacy test found in chapter 51 of the USP 40 manual. All embodiments were between pH 3.95-4.05.

To each of the embodiments, 1×10⁶ cells from the following spoilage organisms; Escheria coli, Listeria monocytogenes, Salmonella entericia, Aspergillus flavus, Aspergillus brasiliensis, and Zygosaccharomyces bailii. The microbials were homogeneously dispersed in the various embodiments. Small aliquots are taken from the inoculated samples at the appropriate time point is serial diluted and plated. The plates are incubated, and growth is then enumerated. The counts are multiplied by the appropriate dilution factor to give a viable cell count at that time point. The cell counts of each inoculated sample over the various time points is enumerated in Table 21.

TABLE 21
Microbial plate count levels upon exposure to various embodiments of the
present food preservative solution and controlled treatments during a week
long time frame at pH 4.0.

| | | | | |
|---|---|---|---|---|
| | | | 500 ppm | |
| | | | Phenylacrylic | 500 ppm |
| | | | Acid | Sorbic Acid |
| | | | 500 ppm | 500 ppm |
| | | | Mandelic Acid | Mandelic Acid |
| | Saline | 1000 ppm | 5000 ppm | 5000 ppm |
| Test Day | (Neg. Control) | Sorbic Acid | Chitosan | Chitosan |

A. brasiliensis

| | | | | | | | | |
|---|---|---|---|---|---|---|---|---|
| 0 | 630000 | CFU/g | 630000 | CFU/g | 630000 | CFU/g | 630000 | CFU/g |
| 0.5 | 570000 | CFU/g | 230000 | CFU/g | 650000 | CFU/g | 110000 | CFU/g |
| 1 | 410000 | CFU/g | 520 | CFU/g | 550000 | CFU/g | 1100 | CFU/g |
| 3 | 430000 | CFU/g | <10 | CFU/g | 30000 | CFU/g | 430 | CFU/g |
| 7 | 480000 | CFU/g | <10 | CFU/g | 5300 | CFU/g | 390 | CFU/g |

A. flavus

| | | | | | | | | |
|---|---|---|---|---|---|---|---|---|
| 0 | 510000 | CFU/g | 510000 | CFU/g | 510000 | CFU/g | 510000 | CFU/g |
| 0.5 | 320000 | CFU/g | 8500 | CFU/g | 370000 | CFU/g | 15000 | CFU/g |
| 1 | 300000 | CFU/g | <10 | CFU/g | 310000 | CFU/g | 10 | CFU/g |
| 3 | 390000 | CFU/g | <10 | CFU/g | 170 | CFU/g | 10 | CFU/g |
| 7 | 350000 | CFU/g | <10 | CFU/g | 30 | CFU/g | <10 | CFU/g |

Z. bailii

| | | | | | | | | |
|---|---|---|---|---|---|---|---|---|
| 0 | 48000 | CFU/g | 480000 | CFU/g | 480000 | CFU/g | 480000 | CFU/g |
| 0.5 | 53000 | CFU/g | 130000 | CFU/g | <10 | CFU/g | <10 | CFU/g |
| 1 | 59000 | CFU/g | 1600 | CFU/g | <10 | CFU/g | <10 | CFU/g |
| 3 | 53000 | CFU/g | 120 | CFU/g | <10 | CFU/g | <10 | CFU/g |
| 7 | 440000 | CFU/g | <10 | CFU/g | <10 | CFU/g | <10 | CFU/g |

E. coli

| | | | | | | | | |
|---|---|---|---|---|---|---|---|---|
| 0 | 580000 | CFU/g | 580000 | CFU/g | 580000 | CFU/g | 580000 | CFU/g |
| 0.5 | 580000 | CFU/g | <10 | CFU/g | <10 | CFU/g | <10 | CFU/g |
| 1 | 580000 | CFU/g | <10 | CFU/g | <10 | CFU/g | <10 | CFU/g |
| 3 | 580000 | CFU/g | <10 | CFU/g | <10 | CFU/g | <10 | CFU/g |
| 7 | 580000 | CFU/g | <10 | CFU/g | <10 | CFU/g | <10 | CFU/g |

S. entericia

| | | | | | | | | |
|---|---|---|---|---|---|---|---|---|
| 0 | 800000 | CFU/g | 800000 | CFU/g | 800000 | CFU/g | 800000 | CFU/g |
| 0.5 | 490000 | CFU/g | <10 | CFU/g | <10 | CFU/g | <10 | CFU/g |
| 1 | 570000 | CFU/g | <10 | CFU/g | <10 | CFU/g | <10 | CFU/g |
| 3 | 540000 | CFU/g | <10 | CFU/g | <10 | CFU/g | <10 | CFU/g |
| 7 | 1700000 | CFU/g | <10 | CFU/g | <10 | CFU/g | <10 | CFU/g |

L. monocytogenes

| | | | | | | | | |
|---|---|---|---|---|---|---|---|---|
| 0 | 620000 | CFU/g | 620000 | CFU/g | 620000 | CFU/g | 620000 | CFU/g |
| 0.5 | 420000 | CFU/g | <10 | CFU/g | <10 | CFU/g | <10 | CFU/g |
| 1 | 310000 | CFU/g | <10 | CFU/g | <10 | CFU/g | <10 | CFU/g |
| 3 | 20000 | CFU/g | <10 | CFU/g | <10 | CFU/g | <10 | CFU/g |
| 7 | <10 | CFU/g | <10 | CFU/g | <10 | CFU/g | <10 | CFU/g |

Each of the embodiments exhibited a broad swath of bactericidal and fungicidal properties. The embodiments exhibited improved antimicrobial efficacy against the Zygosaccharomyces bailii versus the efficacy of the 1000 ppm sorbic acid positive control against the same. All embodiments exhibited both fungicidal and bactericidal activities.

### Experimental Test 7

To determine whether certain embodiments described herein prevent the generation of volatile off products such as styrene, vinyl guaiacol, 1,3 pentadiene, and other products. Certain embodiments containing phenylacrylic acid, mandelic acid, and chitosan were dissolved in yeast extract peptone dextrose media and the pH of each embodiment was made to be between pH 6.0-6.5.

To each of these embodiments 1×10⁴ cells from the spoilage organism; Saccharomyces cerevisiae was inoculated into the YPD media1L of a growth medium was first prepared having the following composition indicated in Table 22.

TABLE 22
Exemplary formulation of growth media.

| Substance | Grams/Liter of Water |
|---|---|
| Asparagine monohydrate | 5.000 g |
| Glucose | 10.000 g |
| MgSO₄•7H₂O | 0.250 g |
| KH₂PO₄ | 0.250 g |
| FeSO₄•7H₂O | 0.001 g |

To the inoculations the embodiments, which are described below, were added and then allowed to incubate for 24 hours in gas chromatograph (GC) headspace analysis vials. The headspace vials were analyzed using an Agilent 6890 GC with a mass spectrometer (e.g. an Agilent 5973 mass spectrometer) using a 60 meter column 0.25d_{f} and a 0.25 mm film thickness. The headspace gas was prepared using a sample incubation oven with an initial temperature of 95° C. with loop temperature of 160° C. with a transfer line of 170° C. with 3 minutes on high shake with 0.5 min pressurization with 3 minutes of equalization. 275 μL of headspace gas was injected using a split 1:1 with an inert gas and the flow rate was 2.2 mL/min of carrier gas. The temperature program of the GC started with 42° C. held for 1 minute, 10 degrees/min ramp to 230° C. hold for 0.2 minute. The samples were then transferred to the MS with a transfer temp of 250° C. The MS scanned an m/z ratio of 35-350 ever 0.2 μs.

A standard sample of 200 ppm styrene was analyzed by dissolving 100 mM of styrene in DSMO and diluting the sample to 1 mM, 500 μM, and 100 μM in water and then extracting the sample using the headspace assay described above. FIG. 7 illustrates a graphical output 700 of the mass spectrometry analysis, which revealed a decisive styrene peak 702 at 7.250 minutes. Thus, the peak 702 indicates the presence of a volatile off product (e.g., styrene). Presence of a volatile styrene off product may be undesirable in the present food preservation solution; therefore, mass spectrometry was performed on a plurality of embodiments of the present food preservation solution to determine if the embodiments presented volatile styrene off products. The experimental embodiments included in the assay included: 1) 200 ppm phenylacrylic acid with 500 ppm mandelic acid; 2) 200 ppm phenylacrylic acid with 2000 ppm chitosan and 200 ppm mandelic acid; and 3) 200 ppm phenylacrylic acid, 200 ppm chitosan, and 200 ppm mandelic acid.

FIG. 8A illustrates a graphical output 800A of the mass spectrometry analysis for an embodiment of the present food preservative solution including 200 ppm trans-phenylacrylic acid and 500 ppm mandelic acid. The graphical output 800A does not feature a decisive styrene peak at 7.250 minutes; therefore, the embodiment of the formulation did not present a volatile styrene off product.

FIG. 8B illustrates a graphical output 800B of the mass spectrometry analysis for an embodiment of the present food preservative solution including 200 ppm phenylacrylic acid, 2000 ppm chitosan and 200 ppm mandelic acid. The graphical output 800B does not feature a decisive styrene peak at 7.250 minutes; therefore, the embodiment of the formulation did not present a volatile styrene off product during experimentation.

FIG. 8C illustrates a graphical output 800C of the mass spectrometry analysis for an embodiment of the present food preservative solution including 200 ppm phenylacrylic acid, 200 ppm chitosan and 200 ppm mandelic acid. The graphical output 800C does not feature a decisive styrene peak at 7.250 minutes; therefore, the embodiment of the formulation did not present a volatile styrene off product during experimentation.

Thus, the embodiments analyzed via mass spectroscopy did not exhibit any volatile off products that are associated with the breakdown of the preservative and antimicrobial compound phenylacrylic acid by the Saccharomyces cerevisiae enzyme FDC1. These results may mark a departure from previously established results from M. Stratford et al 2007, K J. Schwarz et al 2012, P. Richard et al 2015 which established that cinnamaldehyde and phenylacrylic acid broke down to styrene. Blocking the FDC1 enzyme through the use of a potentiating agent, such as mandelic acid, may result in a lack of styrene formation in the samples.

### CONCLUSION

Aspects, features, and benefits of the claimed disclosure(s) will become apparent from the information disclosed in the exhibits and the other applications as incorporated by reference. Variations and modifications to the disclosed systems and methods may be affected without departing from the spirit and scope of the novel concepts of the disclosure.

It will, nevertheless, be understood that no limitation of the scope of the disclosure is intended by the information disclosed in the exhibits or the applications incorporated by reference; any alterations and further modifications of the described or illustrated embodiments, and any further applications of the principles of the disclosure as illustrated therein are contemplated as would normally occur to one of general skill in the art to which the disclosure relates.

The foregoing description of the exemplary embodiments has been presented only for the purposes of illustration and description and is not intended to be exhaustive or to limit the disclosure to the precise forms disclosed. Many modifications and variations are possible in light of the above teaching.

While various aspects have been described in the context of a preferred embodiment, additional aspects, features, and methodologies of the claimed systems will be readily discernible from the description herein, by those of general skill in the art. Many embodiments and adaptations of the disclosure and claimed systems other than those herein described, as well as many variations, modifications, and equivalent arrangements and methodologies, will be apparent from or reasonably suggested by the disclosure and the foregoing description thereof, without departing from the substance or scope of the claims. Furthermore, any sequence(s) and/or temporal order of steps of various processes described and claimed herein are those considered to be the best mode contemplated for carrying out the claimed systems. It should also be understood that, although steps of various processes may be shown and described as being in a preferred sequence or temporal order, the steps of any such processes are not limited to being carried out in any particular sequence or order, absent a specific indication of such to achieve a particular intended result. In most cases, the steps of such processes may be carried out in a variety of different sequences and orders, while still falling within the scope of the claimed systems. In addition, some steps may be carried out simultaneously, contemporaneously, or in synchronization with other steps.

The embodiments were chosen and described in order to explain the principles of the disclosures and their practical application so as to enable others of general skilled in the art to utilize the disclosures and various embodiments and with various modifications as are suited to the particular use contemplated. Alternative embodiments will become apparent to those of general skill in the art to which the present disclosures pertain without departing from their spirit and scope. Accordingly, the scope of the present disclosure is defined by the appended claims rather than the foregoing description and the exemplary embodiments described therein.

What is claimed is:

1. A compound for preserving foodstuffs, comprising:
a preservative agent;
a potentiating agent; and
a stabilizing agent.

2. The compound of claim 1, wherein the preservative agent comprises up to about 90% by weight of the compound.

3. The compound of claim 1, wherein the potentiating agent comprises up to about 50% by weight of the compound.

4. The compound of claim 1, wherein the stabilizing agent comprises up to about 90% by weight of the compound.

5. The compound of claim 1, wherein the preservative agent is selected from the group comprising: phenylacrylic acid, sorbic acid, ferulic acid, and derivatives of any of the preceding.

6. The compound of claim 1, wherein the potentiating agent is selected from the group comprising: L-mandelic acid, D-mandelic acid, 1,2 nitroethanol, and 2,2-(Z)-fluoronitrovinylbenzene, and derivatives of any of the preceding.

7. The compound of claim 1, wherein the stabilizing agent is selected from the group comprising: chitosan, alginate, starch, whey protein isolate, soy protein isolate, and derivatives of any of the preceding.

8. The compound of claim 1, wherein the compound is an aqueous solution.

9. A compound for preserving foodstuffs, comprising:
a preservative agent, wherein the preservative agent is selected from the group comprising: phenylacrylic acid, sorbic acid, ferulic acid, and derivatives of any of the preceding;
a potentiating agent, wherein the potentiating agent is selected from the group comprising: L-mandelic acid, D-mandelic acid, 1,2 nitroethanol, and 2,2-(Z)-fluoronitrovinylbenzene, and derivatives of any of the preceding; and
a stabilizing agent, wherein the stabilizing agent is selected from the group comprising: chitosan, alginate, starch, whey protein isolate, soy protein isolate, and derivatives of any of the preceding.

10. The compound of claim 9, wherein the preservative agent comprises up to about 90% by weight of the compound.

11. The compound of claim 9, wherein the potentiating agent comprises up to about 50% by weight of the compound.

12. The compound of claim 9, wherein the stabilizing agent comprises up to about 90% by weight of the compound.

13. The compound of claim 9, wherein the compound is an aqueous solution.

14. A compound for preserving foodstuffs, comprising:
phenylacrylic acid, wherein the phenylacrylic acid comprises between about 85%-90% by weight of the compound;
mandelic acid, wherein the mandelic acid comprises between about 5%-10% by weight of the compound; and
chitosan, wherein the chitosan comprises about 5% by weight of the compound.

15. A method for preserving a foodstuff, wherein the method comprises:
providing, in a compound, a potentiating agent, a preservative agent and a stabilizing agent; and
applying the compound to the foodstuff.

16. The method of claim 15, wherein the potentiating agent is selected from the group comprising: L-mandelic acid, D-mandelic acid, 1,2 nitroethanol, and 2,2-(Z)-fluoronitrovinylbenzene, and derivatives of any of the preceding.

17. The method of claim 15, wherein the preservative agent is selected from the group comprising: phenylacrylic acid, sorbic acid, ferulic acid, and derivatives of any of the preceding.

18. The method of claim 15, wherein the compound is configured to preserve a foodstuff comprising a pH between about 3-7.5.

19. The method of claim 15, wherein providing further comprises:
selecting the potentiating agent, wherein the potentiating agent is selected from the group comprising: L-mandelic acid, D-mandelic acid, 1,2 nitroethanol, and 2,2-(Z)-fluoronitrovinylbenzene, and derivatives of any of the preceding;
selecting the preservative agent, wherein the preservative agent is selected from the group comprising: phenylacrylic acid, sorbic acid, ferulic acid, and derivatives of any of the preceding; and
selecting the stabilizing agent, wherein the stabilizing agent is selected from the group comprising: chitosan, alginate, starch, whey protein isolate, soy protein isolate, and derivatives of any of the preceding.

20. The method of claim 15, wherein the foodstuff comprises a pH between about 3-7.5.

21. The method of claim 15, wherein the compound is an aqueous solution.
